(19) United States
(12) Patent Application Publication
(10) Pub. No.: US 2025/0037403 A1
(43) Pub. Date: Jan. 30, 2025

(54) DATA PROCESSING METHOD AND APPARATUS FOR VIRTUAL SCENE, DEVICE, AND MEDIUM

(71) Applicant: Tencent Technology(Shenzhen) Company Limited., Shenzhen (CN)

(72) Inventor: Zejun YANG, Shenzhen (CN)

(21) Appl. No.: 18/911,102

(22) Filed: Oct. 9, 2024

Related U.S. Application Data
(63) Continuation of application No. PCT/CN2023/124664, filed on Oct. 16, 2023.

(30) Foreign Application Priority Data
Nov. 11, 2022 (CN) 202211417607.0

(51) Int. Cl. G06T 19/20; G06T 7/11; G06T 7/73; G06T 19/00

(52) U.S. Cl. CPC G06T 19/20; G06T 7/11; G06T 7/73; G06T 19/006; G06T 2207/10016; G06T 2207/20081; G06T 2207/20084; G06T 2207/30196; G06T 2210/16; G06T 2219/2016

(57) ABSTRACT

This application disclose a method for changing an outfit of a virtual object in a virtual scene performed by a computer device. The method includes: segmenting an outfit image of a target outfit from an image of a real object wearing the target outfit; obtaining a first image of the virtual object from a first video of the virtual object, the first video including an action of the virtual object driven by a three-dimensional posture parameter of the real object in a real world; and filling a wearing region in the first image of the virtual object with the outfit image, to obtain an image of the virtual object wearing the target outfit in the virtual scene.

### CROSS-REFERENCE TO RELATED APPLICATIONS

This application is a continuation application of PCT Patent Application No. PCT/CN2023/124664, entitled “DATA PROCESSING METHOD AND APPARATUS FOR VIRTUAL SCENE, DEVICE, AND MEDIUM” filed on Oct. 16, 2023, which claims priority to Chinese Patent Application No. 202211417607.0, entitled “DATA PROCESSING METHOD AND APPARATUS BASED ON WEARING OF VIRTUAL OBJECT, DEVICE, AND MEDIUM” filed with the China National Intellectual Property Administration on Nov. 11, 2022, both of which are incorporated herein by reference in their entirety.

### FIELD OF THE TECHNOLOGY

This application relates to the field of computer technologies, and specifically, to a data processing method for a virtual scene, a data processing apparatus for a virtual scene, an electronic device, and a computer-readable medium.

### BACKGROUND OF THE DISCLOSURE

Technical solutions for dress up in the related art mainly include two types. A solution is to directly perform three-dimensional modeling on a garment required by a virtual object, and perform cloth simulation on a three-dimensional garment during movement of the virtual object, to restore a physical movement state of the clothes during the movement of the virtual object, such as a wrinkle and a swing. Another solution is to implement dressing up based on a deep learning image codec algorithm. A static flattened image or a model try-on image of a specified garment and an action video of a real object model are provided, then a single static garment image is stretched, moved, filled, and cropped to fit a real body in motion according to body key points and body portion parsing and segmentation labels, and then a deep convolutional neural network codec is used to repair the image, to implement the dressing up.

### SUMMARY

Embodiments of this application provide a data processing method and apparatus for a virtual scene, a device, and a medium, to reduce three-dimensional reconstruction and related calculation required in a data processing process, and improve data processing efficiency.

An embodiment of this application provides a method for changing an outfit of a virtual object in a virtual scene performed by an electronic device. The method includes: segmenting an outfit image of a target outfit from an image of a real object wearing the target outfit; obtaining a first image of the virtual object from a first video of the virtual object, the first video including an action of the virtual object driven by a three-dimensional posture parameter of the real object in a real world; and filling a wearing region in the first image of the virtual object with the outfit image, to obtain an image of the virtual object wearing the target outfit in the virtual scene.

An embodiment of this application provides an electronic device, including one or more processors; and a memory, configured to store one or more programs, the one or more programs, when executed by the one or more processors, causing the electronic device to implement the data processing method for a virtual scene as described above.

An embodiment of this application provides a non-transitory computer-readable medium, having a computer program stored therein, the computer program, when executed by a processor of an electronic device, causing the electronic device to implement the data processing method for a virtual scene as described above.

The foregoing general descriptions and the following detailed descriptions are merely for illustration and explanation purposes and are not intended to limit this application.

### BRIEF DESCRIPTION OF THE DRAWINGS

FIG. 1 is a schematic diagram of an exemplary implementation environment in which a technical solution according to an embodiment of this application is applicable.

FIG. 2 is a flowchart of a data processing method for a virtual scene according to some embodiments of this application.

FIG. 3 is a schematic diagram of an image of a real object wearing a target outfit according to some embodiments of this application.

FIG. 4 is a schematic diagram of an outfit image according to some embodiments of this application.

FIG. 5 is a schematic diagram of an image of a virtual object according to some embodiments of this application.

FIG. 6 is a schematic diagram of a dress-up process of a virtual object according to some embodiments of this application.

FIG. 7 is a flowchart of a data processing method for a virtual scene according to some embodiments of this application.

FIG. 8 is a schematic diagram of a transformed outfit image according to some embodiments of this application.

FIG. 9 is a flowchart of a data processing method for a virtual scene according to some embodiments of this application.

FIG. 10 is a flowchart of a data processing method for a virtual scene according to some embodiments of this application.

FIG. 11 is a schematic diagram of an outfit mask image according to some embodiments of this application.

FIG. 12 is a schematic diagram of a second image of a virtual object according to some embodiments of this application.

FIG. 13 is a schematic diagram of a dress-up process of a virtual object according to some embodiments of this application.

FIG. 14 is a flowchart of a data processing method for a virtual scene according to some embodiments of this application.

FIG. 15 is a flowchart of a data processing method for a virtual scene according to some embodiments of this application.

FIG. 16-1 is a schematic diagram of first torso position information according to some embodiments of this application.

FIG. 16-2 is a schematic diagram of second torso position information according to some embodiments of this application.

FIG. 17 is a flowchart of a data processing method for a virtual scene according to some embodiments of this application.

FIG. 18 is a schematic diagram of second limb position information according to some embodiments of this application.

FIG. 19 is a flowchart of a data processing method for a virtual scene according to some embodiments of this application.

FIG. 20 is a flowchart of a data processing method for a virtual scene according to some embodiments of this application.

FIG. 21 is a flowchart of a data processing method for a virtual scene according to some embodiments of this application.

FIG. 22 is a flowchart of a data processing method for a virtual scene according to some embodiments of this application.

FIG. 23 is a schematic diagram of an implementation environment of collecting a video in which a real object wearing a specified outfit performs an action according to some embodiments of this application.

FIG. 24 is a flowchart of a data processing method for a virtual scene according to some embodiments of this application.

FIG. 25 is a flowchart of a data processing method for a virtual scene according to some embodiments of this application.

FIG. 26 is a flowchart of a data processing method for a virtual scene according to some embodiments of this application.

FIG. 27 is a flowchart of a data processing method for a virtual scene according to some embodiments of this application.

FIG. 28 is a flowchart of a data processing method for a virtual scene according to some embodiments of this application.

FIG. 29 is a flowchart of a data processing method for a virtual scene according to some embodiments of this application.

FIG. 30 is a schematic diagram of preprocessing a real person dancing video according to some embodiments of this application.

FIG. 31 is a schematic diagram of preprocessing a virtual person dancing video according to some embodiments of this application.

FIG. 32 is a schematic diagram of model training according to some embodiments of this application.

FIG. 33 is a schematic diagram of model application according to some embodiments of this application.

FIG. 34 is a block diagram of a data processing apparatus for a virtual scene according to some embodiments of this application.

FIG. 35 is a schematic structural diagram of a computer system adapted to implement an electronic device according to an embodiment of this application.

### DESCRIPTION OF EMBODIMENTS

Exemplary embodiments are described in detail herein, and examples of the exemplary embodiments are shown in the accompanying drawings. When the following descriptions are made with reference to the accompanying drawings, unless otherwise indicated, same numbers in different accompanying drawings represent same or similar elements. The following implementations described in the following exemplary embodiments do not represent all implementations that are the same as this application. Instead, they are merely examples of the apparatus and method that are the same as some aspects of this application as recited in the appended claims.

The block diagrams shown in the accompanying drawings is merely a functional entity and does not necessarily correspond to a physically independent entity. That is, the functional entities may be implemented in a software form, or in one or more hardware modules or integrated circuits, or in different networks and/or processor apparatuses and/or microcontroller apparatuses.

The flowcharts shown in the accompanying drawings are merely examples for descriptions, do not necessarily include all content and operations/steps, and are not necessarily performed in the described orders. For example, some operations/steps may be further divided, while some operations/steps may be combined or partially combined. Therefore, an actual execution order may vary depending on an actual situation.

“Plurality of” mentioned in this application means two or more. And/or describes an association relationship for describing associated objects and represents that three relationships may exist. For example, A and/or B may represent the following three cases: only A exists, both A and B exist, and only B exists. The character “/” generally represents an “or” relationship between the associated objects.

In the related art, in a wearing scene of a virtual object (for example, a dress-up scene of a virtual person), three-dimensional modeling is usually performed on a garment to be worn by the virtual object, and cloth simulation is performed on a three-dimensional modeled garment, to restore a physical movement state of the garment clothes during movement of the virtual object (for example, restore a corresponding wrinkle and a corresponding swing of the garment clothes during movement of the virtual object). However, in this manner, three-dimensional modeling and corresponding garment cloth simulation performed on the garment to be worn by the virtual object are required each time. This process is relatively cumbersome, and wearing efficiency of the virtual object is low.

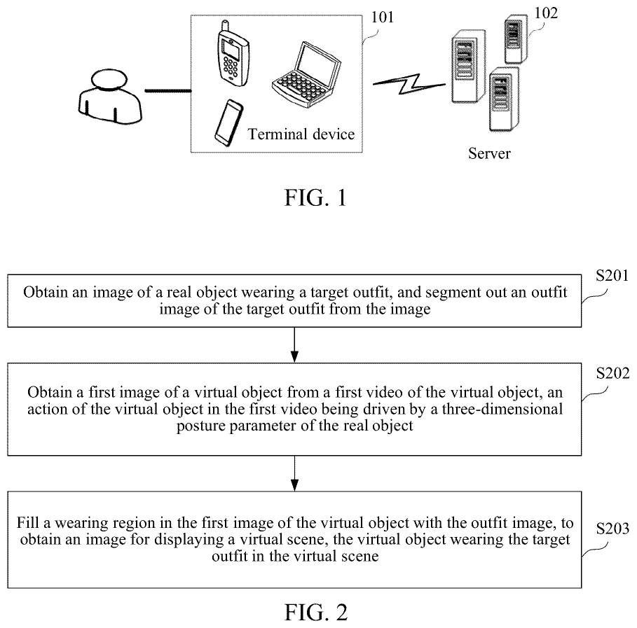

Therefore, to reduce three-dimensional modeling and related calculation required in a data processing process, and improve data processing efficiency, the embodiments of this application provide a data processing method for a virtual scene. FIG. 1 is a schematic diagram of an implementation environment according to this application. The implementation environment mainly includes a terminal device 101 and a server 102. The terminal device 101 may communicate with the server 102 via a wired or wireless network.

The terminal device 101 includes, but is not limited to, a smartphone, a tablet, a notebook computer, a computer, an intelligent voice interaction device, a smart home appliance, an in-vehicle terminal, an aircraft, an extended reality device (for example, a virtual reality (VR) device, an augmented reality (AR) device, and a mixed reality (MR) device), and the like. One or more application programs are installed in the terminal device 101. The application program may be any type of application program, including but not limited to a social type of application program, an entertainment type of application program, and the like. In a use process of these application programs, a human-computer interaction interface is usually displayed. Specifically, a virtual scene may be displayed on the human-computer interaction interface, and the virtual scene includes a virtual object.

The server 102 may be a server that provides various services. The server 102 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middle ware service, a domain name service, a security service, a content delivery network (CDN), big data and an artificial intelligence platform. This is not limited in this application.

Quantities of terminal devices 101 and servers 102 in FIG. 1 are merely exemplary. According to actual requirements, there may be any quantities of terminal devices 101 and servers 102.

In some embodiments of this application, the data processing method for a virtual scene may be performed by the terminal device 101 and/or the server 102.

For example, the terminal device 101 or the server 102 obtains an image of a real object wearing a target outfit, and segments out an outfit image of the target outfit from the image. In some embodiments, the outfit image is an image that includes only an outfit part of the real object and that is obtained from the image of the real object through an image segmentation method. Then a first image of the virtual object before dress up is obtained from a first video of the virtual object. An action of the virtual object in the first video is driven by a three-dimensional posture parameter of the real object; and a wearing region in the first image of the virtual object is filled with the outfit image of the real object, to obtain an image for displaying the virtual scene, the virtual object wearing the target outfit in the virtual scene.

In some embodiments of this application, the data processing method for a virtual scene may be jointly performed by the terminal device 101 and the server 102.

For example, the server 102 obtains an image of a real object wearing a target outfit, and segments out an outfit image of the target outfit from the image; then obtains a first image of the virtual object before dress up from a first video of the virtual object, where an action of the virtual object in the first video is driven by a three-dimensional posture parameter of the real object; and transmits the outfit image and the first image of the virtual object to the terminal device 101.

For example, the terminal device 101 receives the outfit image and the first image of the virtual object that are transmitted by the server 102; and fills a wearing region in the first image of the virtual object with the outfit image, to obtain an image for displaying the virtual scene. The virtual object wears the target outfit in the virtual scene.

The technical solution of the embodiment shown in FIG. 1 may be applied to various virtual scenes, including but not limited to, a virtual scene related to the virtual object. In actual application, an adjustment may be correspondingly made according to a specific scene.

For example, if the solution is applied to a scene involving entertainment such as a game, in the game scene, by implementing the solutions in the embodiments of this application, three-dimensional modeling and related calculation required in a data processing process can be reduced, and data processing efficiency can be improved while a wearing operation on the virtual object is implemented.

For example, the solutions provided in the embodiments of this application may further be applied to a scene involving shopping (online or offline shopping). In a specific implementation of this application, user-related data such as an outfit image is involved. When the foregoing embodiments of this application are applied to specific products or technologies, permission or consent of the user needs to be obtained, and collection, use, and processing of the relevant data need to comply with relevant laws, regulations, and standards of relevant countries and regions.

Various implementation details of the technical solutions of the embodiments of this application are described below in detail.

FIG. 2 is a flowchart of a data processing method for a virtual scene according to some embodiments of this application. The data processing method for a virtual scene may be performed by the server 102. As shown in FIG. 2, the data processing method for a virtual scene includes at least S201 to S203. Detailed descriptions are as follows.

S201: Obtain an image of a real object wearing a target outfit, and segment out an outfit image of the target outfit from the image.

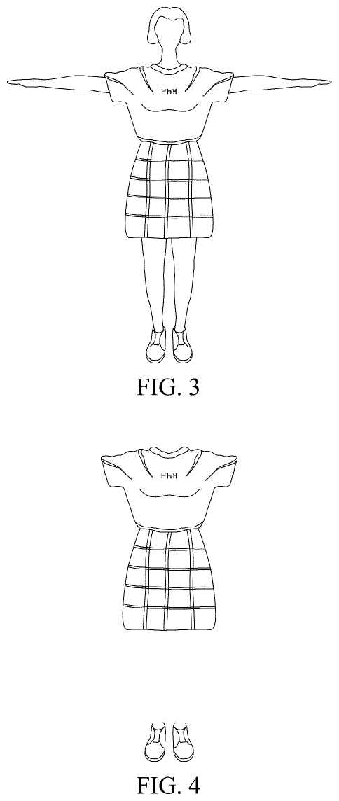

The real object in this embodiment of this application is an object that exists in reality. The real object includes, but is not limited to, a real person, a real animal, and the like. For example, FIG. 3 is an example of a real object, specifically a real person.

The outfit image in this embodiment of this application, which may also be referred to as outfit data, is an image including only the outfit part of the real object, and may be segmented out from the image of the real object by using the image segmentation method. The outfit image may include, but is not limited to, clothing, shoes, a hat, socks, gloves, scarves, a tie, an accessory, a bag, and the like. For example, FIG. 4 is an example of an outfit image of a real object. As shown in FIG. 4, the obtained outfit image may include a short sleeve, a half-body skirt, and shoes. In this embodiment of this application, video data of the real object may be collected, and background segmentation is performed on the video data to obtain a foreground image including the real object. Then, garment segmentation is performed on the foreground image, to obtain the outfit image of the real object.

An outfit represented by the obtained outfit image of the real object in this embodiment of this application is an outfit to be worn by the virtual object in the following description.

S202: Obtain a first image of a virtual object before dress up from a first video of the virtual object, an action of the virtual object in the first video being driven by a three-dimensional posture parameter of the real object.

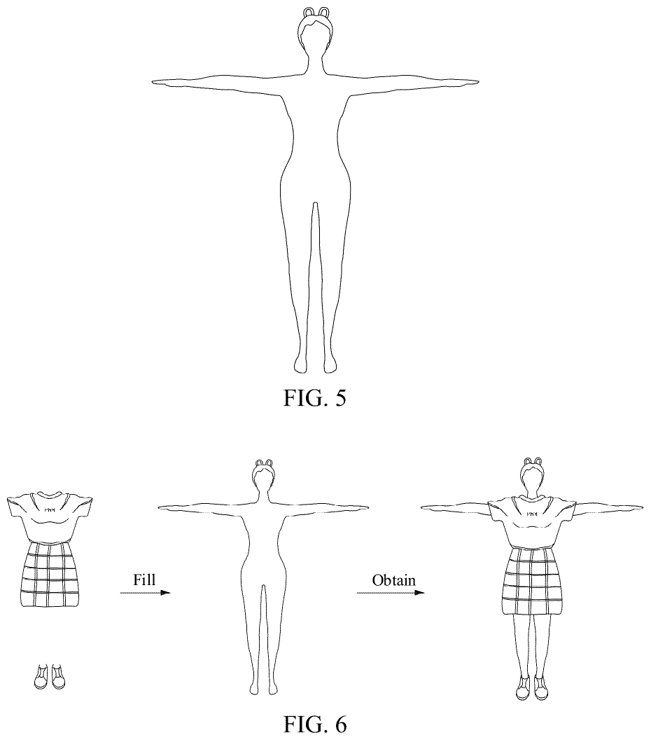

In this embodiment of this application, the virtual object is an object in the virtual scene, which is not a real object. The virtual object includes, but is not limited to, a virtual person, a virtual animal, and the like. For example, FIG. 5 is an example of an image of a virtual object, specifically a virtual person.

In this embodiment of this application, a first image of the virtual object is an image of the virtual object before dress up. If the virtual object is a virtual person, the first image of the virtual object is an image of the virtual person before dress up. If the virtual object is a virtual animal, the first image of the virtual object is an image of the virtual animal before dress up. FIG. 5 is a schematic diagram of the first image of the virtual object (an outfit of the virtual object before dress up is not shown).

In this embodiment of this application, the server obtains the first image of the virtual object from the first video. An action of the virtual object in the first video is driven by the three-dimensional posture parameter of the real object. That is, in this embodiment of this application, the first video is pre-obtained, and the action of the virtual object in the first video is driven based on an action of the real object. For example, as shown in FIG. 3 and FIG. 5, the actions performed by the real object and the virtual object are synchronized.

S203: Fill a wearing region in the first image of the virtual object with the outfit image, to obtain an image for displaying a virtual scene, the virtual object wearing the target outfit in the virtual scene.

In this embodiment of this application, after obtaining the outfit image of the real object and the first image of the virtual object, the server may fill the wearing region in the first image of the virtual object with the outfit image of the real object, to obtain the image for displaying the virtual scene.

As described above, the outfit represented by the outfit image of the real object is exactly the outfit to be worn by the virtual object, and the wearing region of the virtual object may be determined according to the first image of the virtual object. Therefore, the outfit image of the real object is filled into the wearing region in the first image of the virtual object, so that an image of the virtual object wearing the target outfit of the real object can be obtained. In this way, dress up of the virtual object can be implemented and a virtual object after dress up can be displayed in the virtual scene.

For example, FIG. 6 is an example of a dress-up process of a virtual object. This embodiment is obtained by the server by filling the wearing region in the first image of the virtual object shown in FIG. 5 with the outfit image of the real object shown in FIG. 4.

Either of S201 and S202 shown in FIG. 2 may be performed first, or S201 and S202 may be performed simultaneously. In actual application, an adjustment may be flexibly made according to a specific application scenario.

In this embodiment of this application, in a process of implementing wearing of the outfit of the real object on the virtual object, there is no need to perform three-dimensional modeling on the outfit, thereby reducing tedious operations of three-dimensional modeling. In addition, since the actions of the virtual object and the real object are simultaneous, there is no need to perform outfit simulation on the three-dimensional modeled outfit, thereby reducing tedious operations of outfit simulation. In this way, processing efficiency is greatly improved, and processing resources such as three-dimensional modeling and simulation are correspondingly saved.

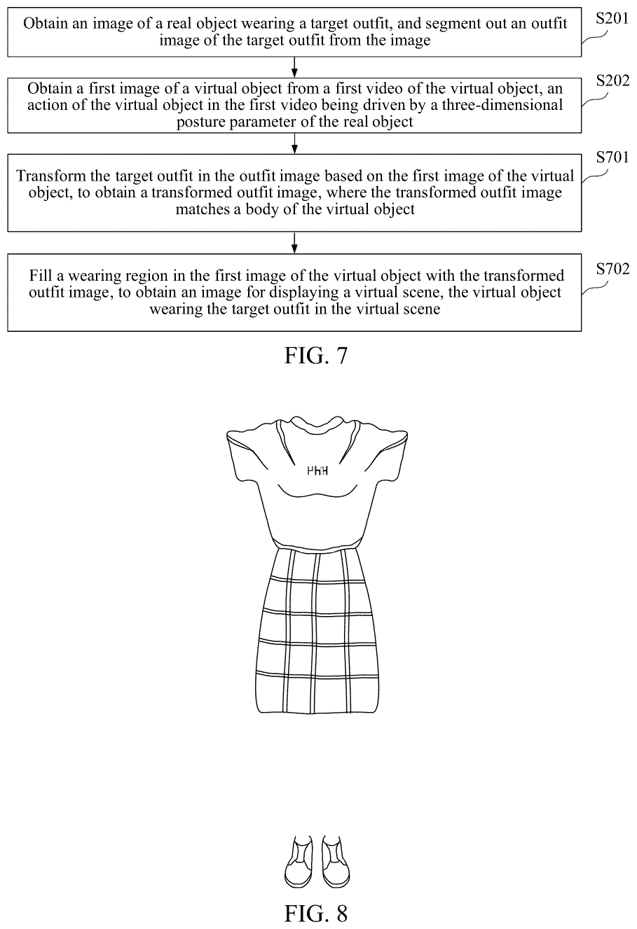

In some embodiments of this application, another data processing method for a virtual scene is provided. The data processing method for a virtual scene may be performed by the server 102. As shown in FIG. 7, the data processing method for a virtual scene may include S701, S702, S201, and S202.

A body of the real object may be different from a body of the virtual object. For example, an overall body of the real object is relatively fat and short, and an overall body of the virtual object is relatively thin and tall. In this case, if the outfit image of the real object is filled into the wearing region in the first image of the virtual object, it is highly likely that the outfit represented by the outfit image does not match the body of the virtual object.

Therefore, in this embodiment of this application, the server may first transform the outfit image of the real object, and then perform filling with a transformed outfit image, so that filling is more natural and fitting.

Detailed descriptions of S701 and S702 are as follows.

S701: Transform a target outfit in an outfit image based on a first image, to obtain a transformed outfit image. The transformed outfit image matches a body of a virtual object.

In this embodiment of this application, the server first transforms the outfit image of the real object based on the first image of the virtual object, to obtain the transformed outfit image. An outfit image before transformation matches a body of the real object, and the transformed outfit image matches the body of the virtual object.

For example, FIG. 8 is an example of the transformed outfit image. The transformed outfit image is obtained by the server by transforming the outfit image of the real object shown in FIG. 4 based on the first image of the virtual object. An outfit represented by the transformed outfit image shown in FIG. 8 is slimer than the outfit represented by the outfit image before transformation shown in FIG. 4, so that the outfit can match the body of the virtual object.

S702: Fill a wearing region in the first image of the virtual object with the transformed outfit image, to obtain an image for displaying a virtual scene, the virtual object wearing the target outfit in the virtual scene.

In this embodiment of this application, the server transforms the outfit image of the real object based on the first image of the virtual object, to obtain the transformed outfit image, and then fills the wearing region in the first image of the virtual object with the transformed outfit image, to obtain the image of the virtual object with the wearing region filled with the transformed outfit image. This avoids a situation in which the outfit represented by the outfit image does not match the body of the virtual object, so that the outfit represented by the outfit image worn by the virtual object is more natural and fitting.

For detailed descriptions of S201 and S202 shown in FIG. 7, refer to S201 and S202 shown in FIG. 2. Details are not described herein again.

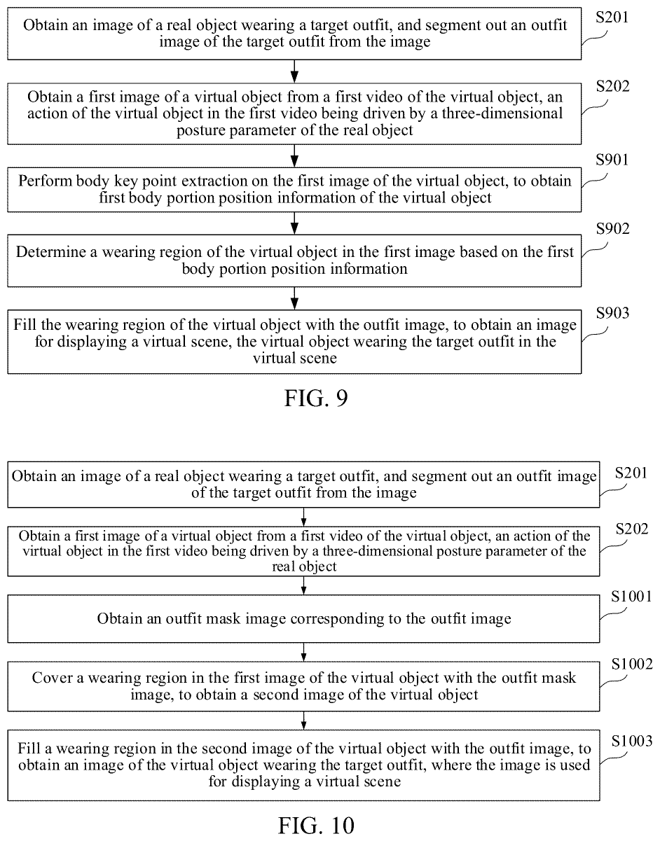

In some embodiments of this application, another data processing method for a virtual scene is provided. The data processing method for a virtual scene may be performed by the server 102. As shown in FIG. 9, the data processing method for a virtual scene may include S901 to S903, S201, and S202.

Detailed descriptions of S901 to S903 are as follows.

S901: Perform body key point extraction on the first image of the virtual object, to obtain first body portion position information of the virtual object.

In this embodiment of this application, the first body portion position information is position information of a body portion of the virtual object. In some embodiments, the first body portion position information may be a key point of a joint corresponding to the body portion of the virtual object.

In some embodiments of this application, the server may perform body key point extraction on the first image through a body posture estimation algorithm, to obtain the first body portion position information. In some embodiments, the body posture estimation algorithm may be OpenPose, which is a bottom-up, deep learning-based two-dimensional posture estimation algorithm.

S902: Determine a wearing region of the virtual object in the first image based on the first body portion position information.

In this embodiment of this application, after performing body key point extraction on the first image of the virtual object to obtain the first body portion position information, the server can determine the wearing region of the virtual object included in the first image of the virtual object based on the first body portion position information. That is, in this embodiment of this application, the server may determine the wearing region of the virtual object from the first image of the virtual object based on the first body portion position information, to provide support for subsequent filling of the outfit image of the real object.

S903: Fill the wearing region of the virtual object with the outfit image, to obtain an image for displaying a virtual scene. The virtual object wears the target outfit in the virtual scene.

In this embodiment of this application, after determining the wearing region of the virtual object included in the first image of the virtual object based on the body portion position information, the server can fill the outfit image of the real object into the wearing region of the virtual object in the first image of the virtual object, so that the image of the virtual object wearing the target outfit of the real object is obtained. In this way, dress up of the virtual object is implemented and a corresponding virtual scene is displayed.

For detailed descriptions of S201 and S202 shown in FIG. 9, refer to S201 and S202 shown in FIG. 2. Details are not described herein again.

In this embodiment of this application, the wearing region of the virtual object is determined based on the body portion position information, so that the wearing region of the virtual object is filled. This is applicable to a wide range of application scenarios.

In some embodiments of this application, another data processing method for a virtual scene is provided. The data processing method for a virtual scene may be performed by the server 102. As shown in FIG. 10, the data processing method for a virtual scene may include S1001 to S1003, S201, and S202.

During filling on the wearing region of the virtual object with the outfit image of the real object, an error in filling or inaccurate filling is usually encountered.

Therefore, in this embodiment of this application, the server first obtains an outfit mask image corresponding to the outfit image of the real object and obtains the first image of the virtual object, then covers the wearing region in the first image of the virtual object with the outfit mask image to obtain a second image of the virtual object, and then fills a wearing region of the virtual object in the second image with the outfit image of the real object, so that filling is more accurate.

Detailed descriptions of S1001 to S1003 are as follows.

S1001: Obtain an outfit mask image corresponding to the outfit image.

In this embodiment of this application, the outfit mask image is an image obtained after binarizing mask processing is performed on the outfit image of the real object. Binarizing mask processing is to extract a required part from an image, and block an unrequired part. In some embodiments, the required part and the unrequired part in the image may be distinguished by 1 and 0, where 1 may represent a mask region, and 0 may represent an unmask region.

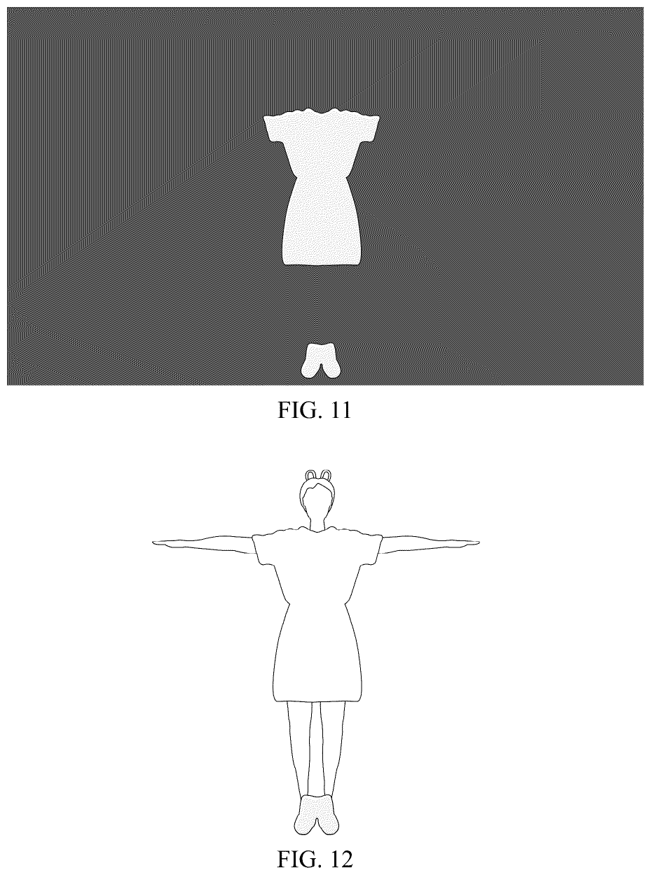

For example, FIG. 11 is an example of an outfit mask image. The outfit mask image is obtained after the server performs binarizing mask processing on the outfit image shown in FIG. 4.

S1002: Cover the wearing region in the first image of the virtual object with the outfit mask image, to obtain a second image of the virtual object.

In this embodiment of this application, after obtaining the outfit mask image corresponding to the outfit image of the real object and obtaining the first image of the virtual object, the server may cover the wearing region in the first image of the virtual object based on the outfit mask image of the real object, to obtain the second image of the virtual object.

For example, FIG. 12 is an example of a second image of a virtual object. The second image is obtained by the server based on the outfit mask image of the real object and the first image of the virtual object.

S1003: Fill a wearing region in the second image of the virtual object with the outfit image, to obtain an image of the virtual object wearing the target outfit, where the image is used for displaying a virtual scene.

In this embodiment of this application, after obtaining the second image of the virtual object based on the outfit mask image of the real object and the first image of the virtual object, the server can fill the outfit image of the real object into the wearing region in the second image of the virtual object, to obtain an image of the virtual object wearing the target outfit of the real object, thereby achieving accurate dress up of the virtual object.

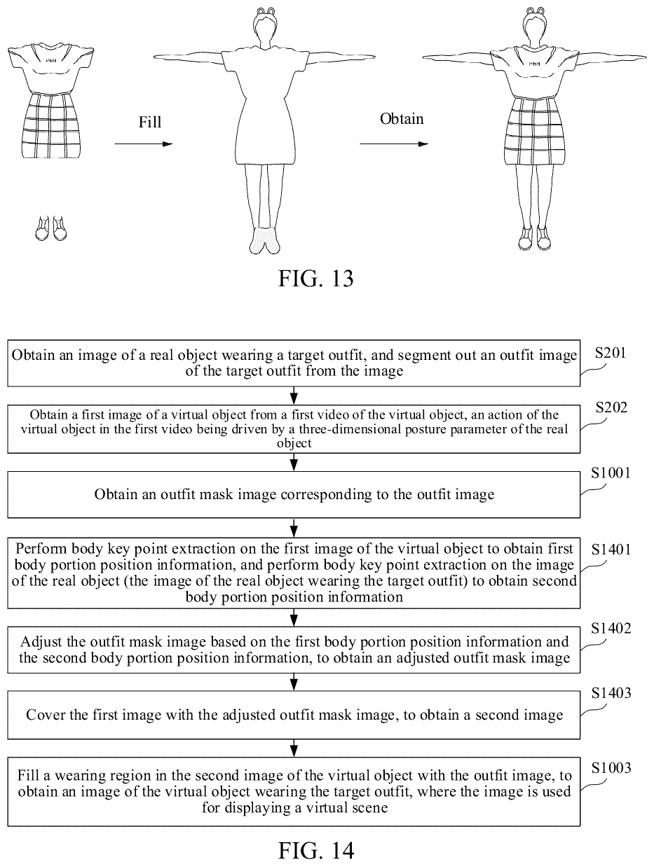

For example, FIG. 13 is an example of a dress-up process of a virtual object. The process is obtained by the server by filling the wearing region in the second image of the virtual object shown in FIG. 12 with the outfit image of the real object shown in FIG. 4.

In some embodiments, the process may further be obtained by the server by filling the wearing region in the second image of the virtual object shown in FIG. 12 with the transformed outfit image shown in FIG. 8.

For detailed descriptions of S201 and S202 shown in FIG. 10, refer to S201 and S202 shown in FIG. 2. Details are not described herein again.

In this embodiment of this application, after the outfit mask image corresponding to the outfit image of the real object is first obtained and the first image of the virtual object is obtained, the second image of the virtual object is correspondingly obtained, and then the wearing region in the second image is filled with the outfit image of the real object, so that filling is more accurate, that is, the virtual object wears the outfit of the real object more accurately.

In some embodiments of this application, another data processing method for a virtual scene is provided. The data processing method for a virtual scene may be performed by the server 102. As shown in FIG. 14, the data processing method for a virtual scene may include S1401 to S1403, S1001, S1003, S201, and S202.

Detailed descriptions of S1401 to S1403 are as follows.

S1401: Perform body key point extraction on the first image of the virtual object to obtain first body portion position information, and perform body key point extraction on the image of the real object (the image of the real object wearing the target outfit) to obtain second body portion position information.

In this embodiment of this application, the first body portion position information is position information of a body portion of the virtual object. In some embodiments, the first body portion position information may be a key point of a joint corresponding to the body portion of the virtual object.

In some embodiments of this application, the server may perform body key point extraction on the first image through a body posture estimation algorithm, to obtain the first body portion position information. In some embodiments, the body posture estimation algorithm may be OpenPose, which is a bottom-up, deep learning-based two-dimensional posture estimation algorithm.

In this embodiment of this application, the second body portion position information is position information of a body portion of the real object. In some embodiments, the second body portion position information may be a key point of a joint corresponding to the body portion of the real object.

In some embodiments of this application, the server may perform body key point extraction on the image of the real object through a body posture estimation algorithm, to obtain the second body portion position information of the real object. In some embodiments, the body posture estimation algorithm may be OpenPose, which is a bottom-up, deep learning-based two-dimensional posture estimation algorithm.

S1402: Adjust the outfit mask image based on the first body portion position information and the second body portion position information, to obtain an adjusted outfit mask image.

In this embodiment of this application, after performing body key point extraction on the first image to obtain the first body portion position information, and performing body key point extraction on the image of the real object to obtain the second body portion position information, the server may adjust the outfit mask image based on the first body portion position information and the second body portion position information, to obtain the adjusted outfit mask image.

S1403: Cover the first image with the adjusted outfit mask image, to obtain a second image.

In this embodiment of this application, the server adjusts the outfit mask image based on the first body portion position information and the second body portion position information, to obtain the adjusted outfit mask image, and then the server may cover the first image using the adjusted outfit mask image, to obtain the second image.

For detailed descriptions of S1001 and S1003 shown in FIG. 14, refer to S1001 and S1003 shown in FIG. 10. For detailed descriptions of S201 and S202 shown in FIG. 14, refer to S201 and S202 shown in FIG. 2. Details are not described herein again.

In this embodiment of this application, the outfit mask image is adjusted based on the first body portion position information and the second body portion position information, to obtain the adjusted outfit mask image, and the first image is covered with the adjusted outfit mask image, to obtain the second image, thereby providing strong support for filling.

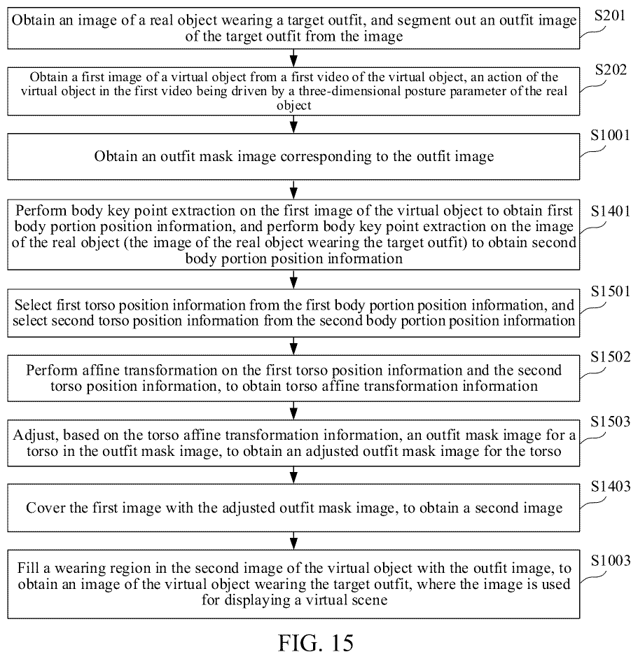

In some embodiments of this application, another data processing method for a virtual scene is provided. The data processing method for a virtual scene may be performed by the server 102. As shown in FIG. 15, the data processing method for a virtual scene may include S1501 to S1503, S1401, S1403, S1001, S1003, S201, and S202.

An outfit represented by the adjusted outfit mask image in the foregoing embodiment may be a T-shirt and a half-body skirt, or may be a T-shirt and pants. For limbs of the body, if the outfit is a skirt, no unnatural situation usually occurs in filling, but if the outfit is pants, an unnatural situation usually occurs in filling. This is mainly due to a difference between the body of the real object and the body of the virtual object.

Therefore, in this embodiment of this application, the server may perform corresponding processing on a torso and the limbs of the body respectively, to obtain the second image.

A process of processing the torso of the body is first described herein.

Detailed descriptions of S1501 to S1503 are as follows.

S1501: Select first torso position information from the first body portion position information, and select second torso position information from the second body portion position information.

In this embodiment of this application, the server first selects the first torso position information from the first body portion position information, and selects the second torso position information from the second body portion position information.

S1502: Perform affine transformation on the first torso position information and the second torso position information, to obtain torso affine transformation information.

In this embodiment of this application, after selecting the first torso position information from the first body portion position information, and selecting the second torso position information from the second body portion position information, the server may perform affine transformation on the first torso position information and the second torso position information, to obtain the torso affine transformation information.

In some embodiments of this application, the first torso position information includes shoulder position information and navel position information of the virtual object, and the second torso position information includes shoulder position information and navel position information of the real object. The process of performing affine transformation on the first torso position information and the second torso position information, to obtain the torso affine transformation information in S1502 may include at least:
calculating an affine transformation matrix based on the shoulder position information and the navel position information of the virtual object and the shoulder position information and the navel position information of the real object; and
using the affine transformation matrix as the torso affine transformation information.

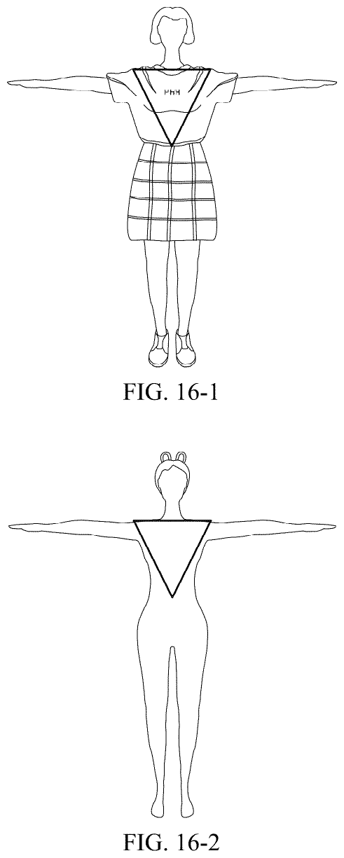

For example, FIG. 16-1 is an example of the first torso position information, where the first torso position information includes the shoulder position information and the navel position information of the virtual object, and may form an inverted triangle. Correspondingly, FIG. 16-2 is an example of the second torso position information, where the second torso position information includes the shoulder position information and the navel position information of the real object, and may form an inverted triangle. Then, the affine transformation matrix between the first torso position information and the second torso position information may be calculated based on the two inverted triangles, to obtain the torso affine transformation information.

S1503: Adjust, based on the torso affine transformation information, an outfit mask image for a torso in the outfit mask image, to obtain an adjusted outfit mask image for the torso.

In this embodiment of this application, after the server performs affine transformation on the first torso position information and the second torso position information to obtain the torso affine transformation information, the server may adjust the outfit mask image for the torso in the outfit mask image based on the torso affine transformation information, to obtain the adjusted outfit mask image for the torso.

In this embodiment of this application, after obtaining the adjusted outfit mask image for the torso, the server may cover the first image with the adjusted outfit mask image for the torso, to obtain the second image. In this way, alignment of the torsos is achieved in the obtained second image.

For detailed descriptions of S1401 and S1403 shown in FIG. 15, refer to S1401 and S1403 shown in FIG. 14. For detailed descriptions of S1001 and S1003 shown in FIG. 15, refer to S1001 and S1003 shown in FIG. 10. For detailed descriptions of S201 and S202 shown in FIG. 15, refer to S201 and S202 shown in FIG. 2. Details are not described herein again.

In this embodiment of this application, corresponding processing is separately performed on the torso of the body, to obtain the second image. This avoids unnatural covering of the obtained second image caused by uniformly performing processing on the body.

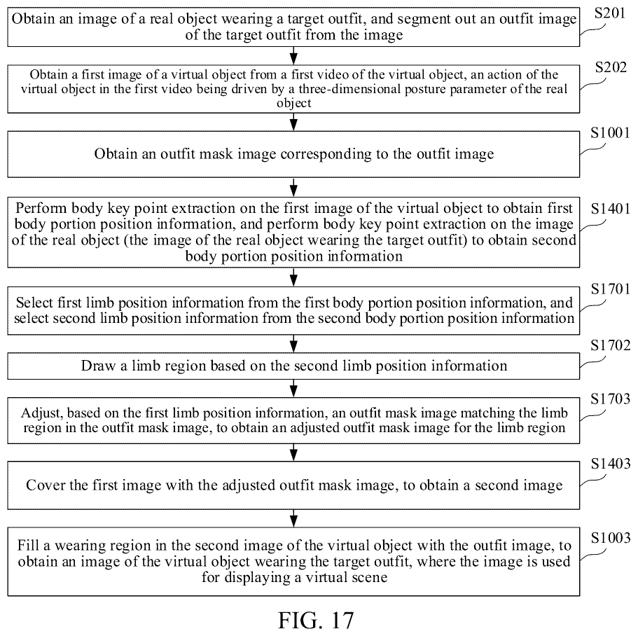

In some embodiments of this application, another data processing method for a virtual scene is provided. The data processing method for a virtual scene may be performed by the server 102. As shown in FIG. 17, the data processing method for a virtual scene may include S1701 to S1703, S1401, S1403, S1001, S1003, S201, and S202.

In this embodiment of this application, the server may perform corresponding processing on the torso and the limbs of the body respectively, to obtain the second image.

A process of processing the limbs of the body is described herein.

Detailed descriptions of S1701 to S1703 are as follows.

S1701: Select first limb position information from the first body portion position information, and select second limb position information from the second body portion position information.

In this embodiment of this application, the server first selects the first limb position information from the first body portion position information, and selects the second limb position information from the second body portion position information.

S1702: Draw a limb region based on the second limb position information.

In this embodiment of this application, after selecting the first limb position information from the first body portion position information, and selecting the second limb position information from the second body portion position information, the server draws the limb region based on the second limb position information.

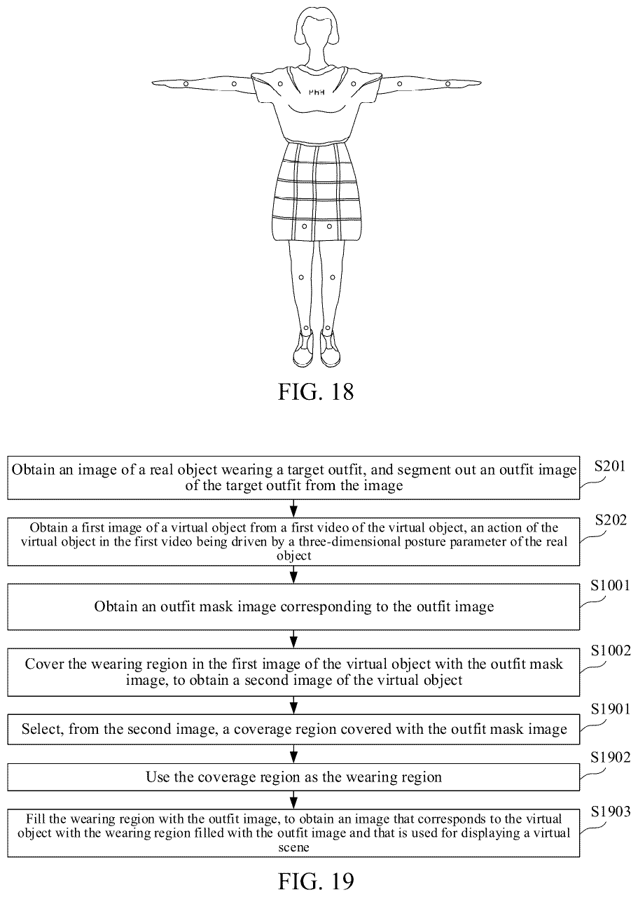

For example, FIG. 18 is an example of second limb position information. The second limb position information includes key points of joints corresponding to limbs (there are 12 key points shown in FIG. 18). Based on the key points of the joints corresponding to the limbs, a limb region corresponding to eight bones may be drawn.

S1703: Adjust, based on the first limb position information, an outfit mask image matching the limb region in the outfit mask image, to obtain an adjusted outfit mask image for the limb region.

In this embodiment of this application, after drawing the limb region based on the second limb position information, the server may adjust, based on the first limb position information, the outfit mask image matching the limb region in the outfit mask image, to obtain the adjusted outfit mask image for the limb region.

For example, following the foregoing example, the outfit mask image under the limb region corresponding to the eight bones is translationally stretched to be aligned with the limb region represented by the first limb position information, to obtain the adjusted outfit mask image for the limb region.

In this embodiment of this application, after obtaining the adjusted outfit mask image for the limb region, the server may cover the first image through the adjusted outfit mask image for the limb region, to obtain the second image. In this way, alignment of the limbs is achieved in the obtained second image.

For detailed descriptions of S1401 and S1403 shown in FIG. 17, refer to S1401 and S1403 shown in FIG. 14. For detailed descriptions of S1001 and S1003 shown in FIG. 17, refer to S1001 and S1003 shown in FIG. 10. For detailed descriptions of S201 and S202 shown in FIG. 17, refer to S201 and S202 shown in FIG. 2. Details are not described herein again.

In this embodiment of this application, corresponding processing is separately performed on the limbs of the body, to obtain the second image. This avoids unnatural covering of the obtained second image caused by uniformly performing processing on the body.

In some embodiments of this application, another data processing method for a virtual scene is provided. The data processing method for a virtual scene may be performed by the server 102. As shown in FIG. 19, the data processing method for a virtual scene may include S1901 to S1903, S1001, S1002, S201, and S202.

Detailed descriptions of S1901 to S1903 are as follows.

S1901: Select, from the second image, a coverage region covered with the outfit mask image.

In this embodiment of this application, the server may select, from the second image, the coverage region covered with the outfit mask image. For example, as shown in FIG. 11, a coverage region covered with the outfit mask image, that is, a white region in the body, may be selected from the second image.

S1902: Use the coverage region as the wearing region.

In this embodiment of this application, the server selects, from the second image, the coverage region covered with the outfit mask image, and may use the coverage region as the wearing region, to provide support for subsequent filling of the outfit image of the real object.

S1903: Fill the wearing region with the outfit image, to obtain an image that corresponds to the virtual object wearing the target outfit, where the image is used for displaying a virtual scene.

In this embodiment of this application, after determining the wearing region, the server can fill the outfit image of the real object into the wearing region of the virtual object in the second image, to obtain the image of the virtual object wearing the target outfit of the real object, thereby achieving fast and accurate dress up of the virtual object.

For detailed descriptions of S1001 and S1002 shown in FIG. 19, refer to S1001 and S1002 shown in FIG. 10. For detailed descriptions of S201 and S202 shown in FIG. 19, refer to S201 and S202 shown in FIG. 2. Details are not described herein again.

In this embodiment of this application, the coverage region covered with the outfit mask image is selected from the second image as the coverage region, so that the wearing region of the virtual object is filled. This is applicable to a wide range of application scenarios.

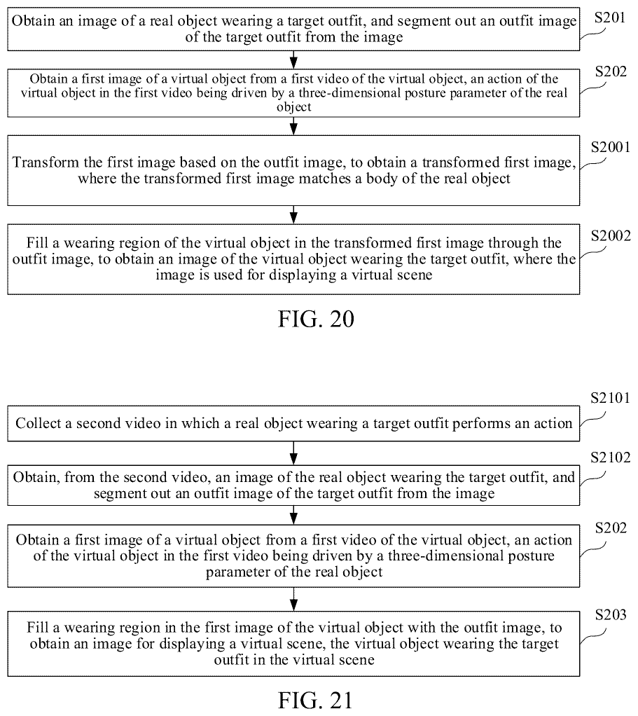

In some embodiments of this application, another data processing method for a virtual scene is provided. The data processing method for a virtual scene may be performed by the server 102. As shown in FIG. 20, the data processing method for a virtual scene may include S2001, S2002, S201, and S202.

A body of the real object may be different from a body of the virtual object. For example, an overall body of the real object is relatively fat and short, and an overall body of the virtual object is relatively thin and tall. In this case, if the outfit image of the real object is filled into the wearing region of the virtual object in the first image of the virtual object, it is highly likely that the outfit represented by the outfit image does not match the body of the virtual object.

Therefore, in this embodiment of this application, the server may first transform the first image of the virtual object, and then fill a transformed first image, so that filling is more natural and fitting.

Detailed descriptions of S2001 and S2002 are as follows.

S2001: Transform the first image based on the outfit image, to obtain a transformed first image, where the transformed first image matches a body of the real object.

In this embodiment of this application, the server first transforms the first image of the virtual object based on the outfit image of the real object, to obtain the transformed first image. A first image before transformation matches the body of the virtual object, and the transformed first image matches the body of the real object.

S2002: Fill a wearing region of the virtual object in the transformed first image with the outfit image, to obtain an image of the virtual object wearing the target outfit, where the image is used for displaying a virtual scene.

In this embodiment of this application, the server transforms the first image of the virtual object based on the outfit image of the real object, to obtain the transformed first image, and then fills the wearing region of the virtual object in the transformed first image with the outfit image of the real object, to obtain the image of the virtual object wearing the target outfit. This avoids a situation in which the outfit represented by the outfit image does not match the body of the virtual object, so that the outfit represented by the outfit image worn by the virtual object is more natural and fitting.

In the foregoing embodiment, a process of transforming the outfit image of the real object is described, while in this embodiment of this application, a process of transforming the first image of the virtual object is described. For a specific process of transforming the first image of the virtual object, refer to a specific process of transforming the outfit image of the real object. Details are not described herein again.

For detailed descriptions of S1001 and S1002 shown in FIG. 20, refer to S1001 and S1002 shown in FIG. 10. For detailed descriptions of S201 and S202 shown in FIG. 20, refer to S201 and S202 shown in FIG. 2. Details are not described herein again.

In this embodiment of this application, the first image of the virtual object is first transformed, and then the transformed first image is filled, so that filling is more natural and fitting, that is, the virtual object wears the outfit of the real object more naturally and fittingly.

In some embodiments of this application, another data processing method for a virtual scene is provided. The data processing method for a virtual scene may be performed by the server 102. As shown in FIG. 21, the data processing method for a virtual scene may include S2101, S2102, S202, and S203.

Detailed descriptions of S2101 and S2102 are as follows.

S2101: Collect a second video in which a real object wearing a target outfit performs an action.

In this embodiment of this application, the server may pre-collect the second video in which the real object wearing the target outfit performs the action.

In some embodiments of this application, the process of collecting a second video in which a real object wearing a target outfit performs an action in S2101 may at least include:

collecting, based on a visual dynamic capture system, the second video in which the real object wearing the target outfit performs the action.

Different from the inertial and optical dynamic capture systems in the related art, the visual dynamic capture system is motion capture implemented by using computer vision, and does not need to rely on any wearable dynamic capture device. Therefore, in this embodiment of this application, the second video in which the real object wearing a specific outfit perform the action is collected through the visual dynamic capture system. The outfit worn by the real object may not be limited. This is applicable to a wider range of application scenarios.

S2102: Obtain, from the second video, an image of the real object wearing the target outfit, and segment out an outfit image of the target outfit from the image.

In this embodiment of this application, after collecting the second video in which the real object wearing the target outfit performs the action, the server may obtain, from the second video, the image of the real object wearing the target outfit.

For detailed descriptions of S202 and S203 shown in FIG. 21, refer to S202 and S203 shown in FIG. 2. Details are not described herein again.

In this embodiment of this application, the second video in which the real object wearing the target outfit performs the action is pre-collected. In this way, the outfit image of the real object can be directly obtained from the second video when the virtual object has a wearing need. This improves a rate of obtaining the outfit image of the real object, and provides strong support for wearing of the virtual object.

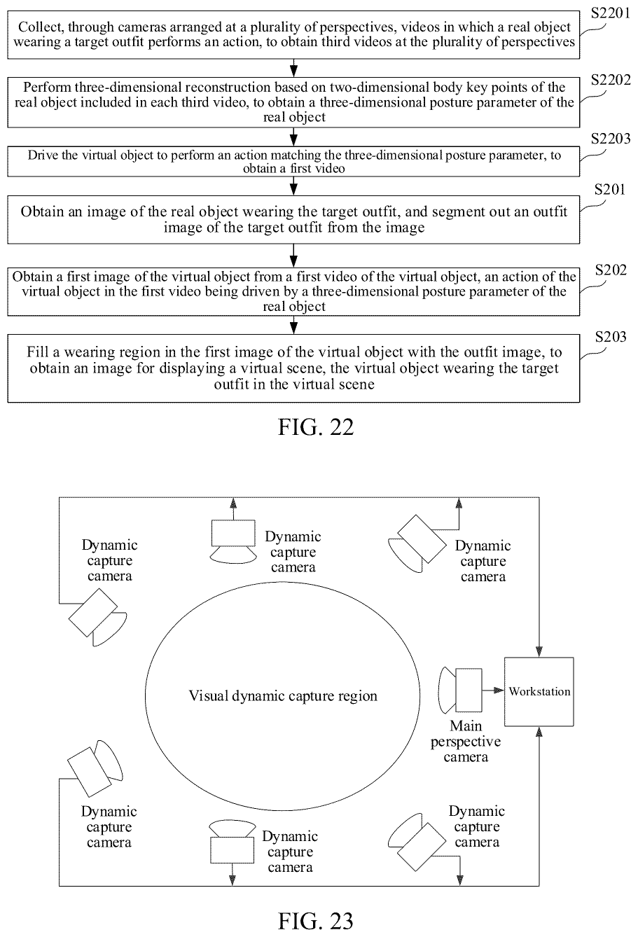

In some embodiments of this application, another data processing method for a virtual scene is provided. The data processing method for a virtual scene may be performed by the server 102. As shown in FIG. 22, the data processing method for a virtual scene may further include S2201 to S2203 before S202.

Detailed descriptions of S2201 and S2203 are as follows.

S2201: Collect, through cameras arranged at a plurality of perspectives, videos in which a real object wearing a target outfit performs an action, to obtain third videos at the plurality of perspectives.

This operation in this embodiment of this application is associated with the process of obtaining the second video in the foregoing embodiment. The third videos at the plurality of perspectives may be understood as the plurality of third videos obtained in the process of obtaining the second video. The server collects, through the cameras at the plurality of perspectives arranged by the visual capture system, the videos in which the real object wearing the target outfit performs the action, to obtain the third videos from the plurality of perspectives, that is, a perspective corresponds to a third video, and a plurality of perspectives correspond to a plurality of third videos.

For example, FIG. 23 is an example of an implementation environment of collecting a video in which a real object wearing a target outfit performs an action. As shown in FIG. 23, a main perspective camera and six dynamic capture cameras are mainly included. The main perspective camera and the six dynamic capture cameras all establish communication connection with a workstation, and an intermediate region is a visual dynamic capture region. That is, the real object wearing the target outfit performs the action in the visual dynamic capture region.

S2202: Perform three-dimensional reconstruction based on two-dimensional body key points of the real object included in each third video, to obtain a three-dimensional posture parameter of the real object.

In this embodiment of this application, the cameras arranged at the plurality of perspectives are used to collect the videos in which the real object wearing a specified outfit performs the action, to obtain the third videos from the plurality of perspectives. Then, three-dimensional reconstruction can be performed based on the two-dimensional body key points of the real object included in each third video, to obtain the three-dimensional posture parameter of the real object.

S2203: Drive the virtual object to perform an action matching the three-dimensional posture parameter, to obtain the first video.

In this embodiment of this application, three-dimensional reconstruction is performed based on the two-dimensional body key points of the real object included in each third video, to obtain the three-dimensional posture parameter of the real object, and then the virtual object can be driven to perform the action matching the three-dimensional posture parameter, to obtain the first video.

For detailed descriptions of S201 to S203 shown in FIG. 22, refer to S201 to S203 shown in FIG. 2. Details are not described herein again.

In this embodiment of this application, through three-dimensional reconstruction on the two-dimensional body key points, a video (that is, the first video) in which the virtual object performs an action matching the real object is quickly obtained, which provides strong support for wearing of the virtual object.

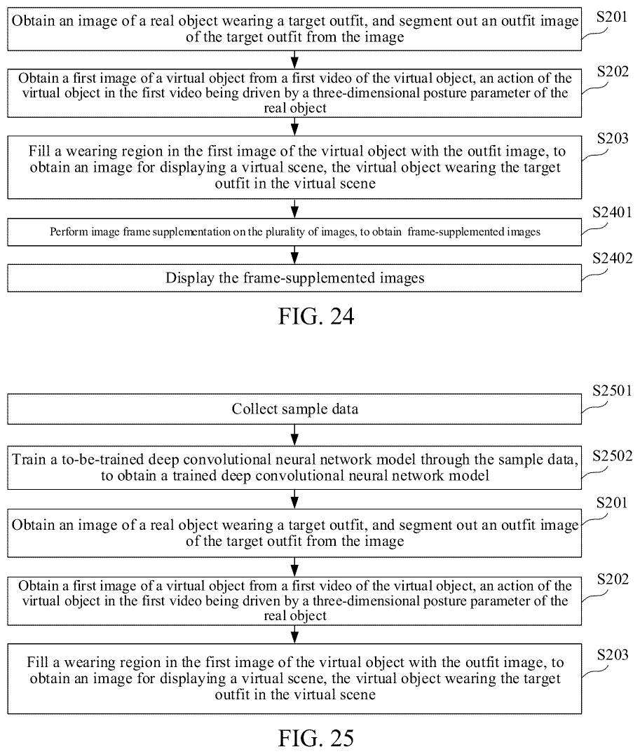

In some embodiments of this application, another data processing method for a virtual scene is provided. The data processing method for a virtual scene may be performed by the server 102. As shown in FIG. 24, the data processing method for a virtual scene may further include S2401 and S2402 after S203.

In this embodiment of this application, a finally obtained image for displaying the virtual scene (that is, the image of the virtual object wearing the target outfit) includes a plurality of images.

Although a plurality of images are obtained, a video formed by the plurality of images may have a phenomenon that the virtual object wears an outfit incoherently.

Therefore, in this embodiment of this application, after obtaining the plurality of images of the virtual object, the server may first perform image frame supplementation on the plurality of images of the virtual object, so that the virtual object wears the outfit more consistently.

Detailed descriptions of S2401 and S2402 are as follows.

S2401: Perform image frame supplementation on the plurality of images, to obtain frame-supplemented images.

In this embodiment of this application, the server may perform image frame supplementation on the plurality of images by using an optical flow frame supplementing algorithm, to obtain the frame-supplemented images.

For example, there are N frames of images, and first, 2 times frame supplementing is performed to obtain 2N-1 frames of images. Since the last frame of the N frames of images cannot generate a next frame, the 2N-1 frames of images are obtained instead of 2N frames of images. In short, N-1 frames are supplemented in N-1 intervals of the N frames of images. All odd frames are original images, and even frames are images generated through frame supplementation.

Then, all even frame images (a total of N-1 frames) may be extracted and 2 times frame supplementation is performed again, to obtain 2N-3 frames of images. In this case, all even frames are smoothing results of the original N frames of images. In this case, all even frames may be selected from the 2N-3 frames of images, the first frame and the last frame may be selected from the original N frames of images, and selected images are used as the frame-supplemented images.

Only an example of frame supplementation is used herein to obtain the frame-supplemented images. In actual application, an adjustment may be flexibly made according to a specific application scenario, for example, a quantity of 2 times frame supplementation and selection of a specific frame are performed.

S2402: Display the frame-supplemented images.

In this embodiment of this application, the server performs image frame supplementation on the plurality of images to obtain the frame-supplemented images, and then the frame-supplemented images can be displayed.

In some embodiments of this application, the server may form the frame-supplemented images into a video and then transmit the video to the terminal device, and then the terminal device plays the video for the user to view.

In some embodiments of this application, if an execution entity is the terminal device, the terminal device may alternatively form the frame-supplemented images into a video, and then play the video for the user to view.

For detailed descriptions of S201 to S203 shown in FIG. 24, refer to S201 to S203 shown in FIG. 2. Details are not described herein again.

In this embodiment of this application, after the plurality of images of the virtual object are obtained, image frame supplementation is performed on the plurality of images of the virtual object, so that the outfit of the virtual object is more consistent.

In some embodiments of this application, another data processing method for a virtual scene is provided. The data processing method for a virtual scene may be performed by the server 102. As shown in FIG. 25, the data processing method for a virtual scene may further include S2501 and S2502 before S201.

To further improve processing efficiency, in this embodiment of this application, the wearing region of the virtual object in the first image is filled with the outfit image by using a deep convolutional neural network model (which may also be referred to as a wearing model), to obtain an image corresponding to the virtual object with a wearing region filled with the outfit image.

A training process of the wearing model is described herein.

Detailed descriptions of S2501 and S2502 are as follows.

S2501: Collect sample data.

In this embodiment of this application, the server first collects the sample data. The sample data includes an outfit sample image, and a first sample image and a second sample image of a sample real object; and the second sample image is obtained by covering a wearing region in the first sample image.

S2502: Train a to-be-trained deep convolutional neural network model through the sample data, to obtain a trained deep convolutional neural network model.

In this embodiment of this application, after collecting the sample data, the server can train the to-be-trained deep convolutional neural network model through the sample data, to obtain the trained deep convolutional neural network model. In this way, when the virtual object has a need for dress up, implementation can be performed by using the trained deep convolutional neural network model. This can greatly improve wearing efficiency of the virtual object.

For detailed descriptions of S201 to S203 shown in FIG. 25, refer to S201 to S203 shown in FIG. 2. Details are not described herein again.

In this embodiment of this application, the wearing model is obtained through pre-training, and then through the wearing model, the wearing region of the virtual object in the first image is filled with the outfit image, to obtain the image corresponding to the virtual object wearing the target outfit. This further improves the processing efficiency, and is applicable to a wide range of application scenarios.

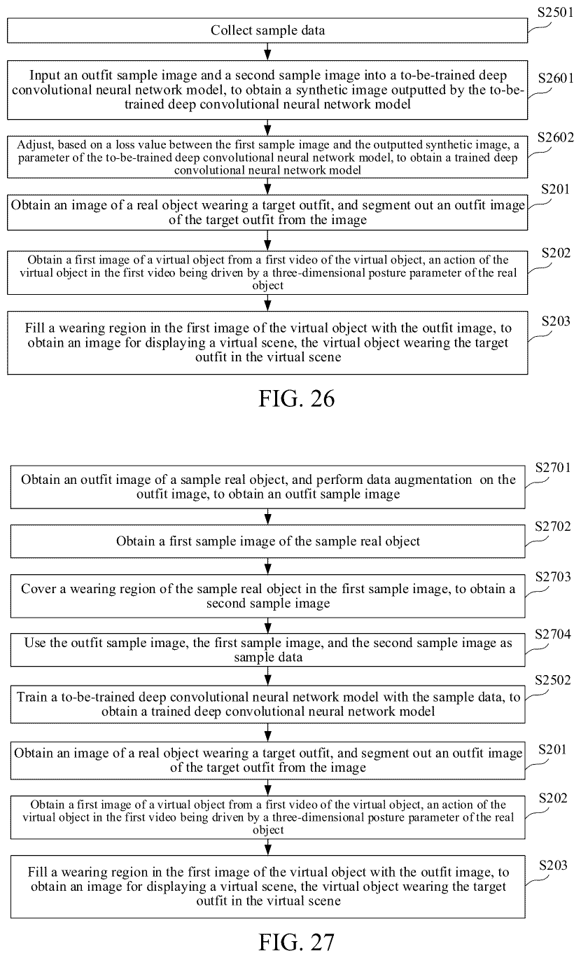

In some embodiments of this application, another data processing method for a virtual scene is provided. The data processing method for a virtual scene may be performed by the server 102. As shown in FIG. 26, the data processing method for a virtual scene may include S2601, S2602, S2501, and S201 to S203.

In this embodiment of this application, the sample data includes an outfit sample image, a first sample image, and a second sample image.

The outfit sample image is an outfit image required for model training, and may be obtained after augmenting an outfit image obtained from a video of the sample real object with reference to the foregoing embodiment.

The first sample image is an image of the sample real object required for model training, and may alternatively be obtained from the video of the sample real object with reference to the foregoing embodiment.

The second sample image is a second image required for model training, and may be obtained after a wearing region of the sample real object in the first sample image is covered with reference to the foregoing embodiment.

Detailed descriptions of S2601 and S2602 are as follows.

S2601: Input an outfit sample image and a second sample image into a to-be-trained deep convolutional neural network model, to obtain a synthetic image outputted by the to-be-trained deep convolutional neural network model.

In this embodiment of this application, the server may input the outfit sample image and the second sample image into the to-be-trained model, to obtain the synthetic image outputted by the to-be-trained model.

In some embodiments of this application, a process of inputting the outfit sample image and the second sample image into the to-be-trained model, to obtain a synthetic image outputted by the to-be-trained model in S2601 may at least include:
inputting the outfit sample image and the second sample image into the to-be-trained model; and
transforming the outfit sample image through the to-be-trained model, and adjusting (for example, position adjustment, random dilation, corrosion, or small-amplitude affine transformation) a wearing region in the second sample image to obtain wearing regions in a plurality of states corresponding to different adjustment manners, to obtain the synthetic image outputted by the to-be-trained model.

In the training process, data of a real object is used. However, the data of the real object is directly used to train the model. Since there are differences between the position and the body of the virtual object and those of the real object in a picture, robustness of a dress-up effect of the model on the virtual object in this case is poor, resulting in problems such as failure to align garment, misplacement of joints, and exposure of limbs. To resolve this problem, two data augmentation methods are introduced to the data (original data) of the real object in this embodiment of this application. One is to generate a random affine transformation matrix on each frame of image of the real object, and then perform uniform affine transformation on all data in a current frame except the outfit image and an outfit binary mask. This method can enable the model to learn how to align the outfit with the torso of the real object. The other is to adjust the wearing region of the real object (for example, random dilation, corrosion, and small-amplitude affine transformation). This is because the virtual object needs to move and transform the outfit when generating the outfit mask image. Through this method, the model can get rid of dependence on an edge feature of the coverage region when generating the outfit, so that the outfit can also be effectively generated on the transformed coverage region of the virtual object. That is, in this embodiment of this application, the outfit sample image and the second sample image are inputted into the to-be-trained model. Then, the to-be-trained model transforms the outfit sample image (that is, learning of outfit transformation), and performs position adjustment on the wearing region in the second sample image to obtain a multi-state wearing region (that is, learning of dress up, where the learning reduces dependence on the edge feature of the coverage region), to obtain the synthetic image outputted by the to-be-trained model.

S2602: Adjust, based on a loss value between the first sample image and the outputted synthetic image, a parameter of the to-be-trained deep convolutional neural network model, to obtain a trained deep convolutional neural network model.

In this embodiment of this application, after inputting the outfit sample image and the second sample image into the to-be-trained model to obtain the synthetic image outputted by the to-be-trained model, the server can adjust the parameter of the to-be-trained model based on the loss value between the first sample image and the outputted synthetic image, to obtain the trained wearing model.

The first sample image may be considered as expected data, and the synthetic image outputted by the to-be-trained model is actual data. Therefore, in this embodiment of this application, the parameter of the to-be-trained model may be adjusted based on the loss value between the expected data and the actual data, and then training is iteratively performed, to obtain the trained wearing model.

For detailed descriptions of S2501 shown in FIG. 26, refer to S2501 shown in FIG. 25. For detailed descriptions of S201 to S203 shown in FIG. 26, refer to S201 to S203 shown in FIG. 2. Details are not described herein again.

In this embodiment of this application, the to-be-trained model is trained through the outfit sample image, the first sample image, and the second sample image, so that the wearing model can be quickly obtained through training. This process is applicable to a wide range of application scenarios.

In some embodiments of this application, another data processing method for a virtual scene is provided. The data processing method for a virtual scene may be performed by the server 102. As shown in FIG. 27, the data processing method for a virtual scene may include S2701 to S2704, S2502, and S201 to S203.

Detailed descriptions of S2701 to S2704 are as follows.

S2701: Obtain an outfit image of a sample real object, and perform data augmentation on the outfit image, to obtain an outfit sample image.

In this embodiment of this application, with reference to the foregoing embodiment, the server may obtain the outfit image of the sample real object from the video of the sample real object, and then perform data augmentation on an obtained outfit image of the sample real object, to obtain the outfit sample image.

In this embodiment of this application, the data augmentation is adjusting a position, a size, and the like of the outfit represented by the outfit image, to add outfit images different from outfit images obtained directly from the video of the sample real object, so that the model can be better trained during model training and robustness of the trained wearing model can be improved.

S2702: Obtain a first sample image of the sample real object.

In this embodiment of this application, with reference to the foregoing embodiment, the server can obtain the first sample image of the sample real object from the video of the sample real object.

In actual application, according to an actual application scenario, the obtained image of the sample real object may also be correspondingly processed, to obtain the first sample image.

S2703: Cover a wearing region of the sample real object in the first sample image, to obtain a second sample image.

In this embodiment of this application, after obtaining the first sample image of the sample real object, the server can cover the wearing region of the sample real object in the first sample image, to obtain the second sample image.

In this embodiment of this application, the covering is blocking the wearing region of the sample real object in the first sample image, so that the to-be-trained model can learn how to better fill the outfit sample image into the wearing region of the real object in the second sample image, so that the model can be better trained during model training, and filling accuracy of the trained wearing model can be improved.

In some embodiments of this application, a process of covering a wearing region of the sample real object in the first sample image, to obtain a second sample image in S2703 may include at least:
obtaining an outfit mask sample image corresponding to the outfit sample image; and
covering the first sample image through the outfit mask sample image, to obtain the second sample image.

That is, in this embodiment of this application, the server covers the first sample image by using the outfit mask sample image corresponding to the outfit sample image, to obtain the second sample image. The outfit mask sample image is an image obtained after binarizing masking is performed on the outfit sample image. A process of obtaining the second sample image is similar to the process of obtaining the second image described in the foregoing embodiment. Details are not described herein again.

S2704: Use the outfit sample image, the first sample image, and the second sample image as sample data.

In this embodiment of this application, the server obtains the outfit sample image, the first sample image, and the second sample image. In this case, the obtained outfit sample image, the obtained first sample image, and the obtained second sample image may be used as the sample data.

Any one of S2701, S2702, and S2703 shown in FIG. 27 may be performed first, or S2701, S2702, and S2703 may be performed simultaneously. For detailed descriptions of S2502 shown in FIG. 27, refer to S2502 shown in FIG. 25. For detailed descriptions of S201 to S203 shown in FIG. 27, refer to S201 to S203 shown in FIG. 2. Details are not described herein again.

In this embodiment of this application, data augmentation is performed on the outfit image to obtain the outfit sample image, and the wearing region of the real object in the first sample image is covered to obtain the second sample image, so that corresponding sample data is obtained, thereby providing strong support for training of the wearing model.

Some specific scenarios in the embodiments of this application are described in detail below. In this embodiments of this application, an example in which the real object is a real person and the virtual object is a virtual person is used.

First, an overall process in which the virtual person wears an outfit of the real person is introduced.

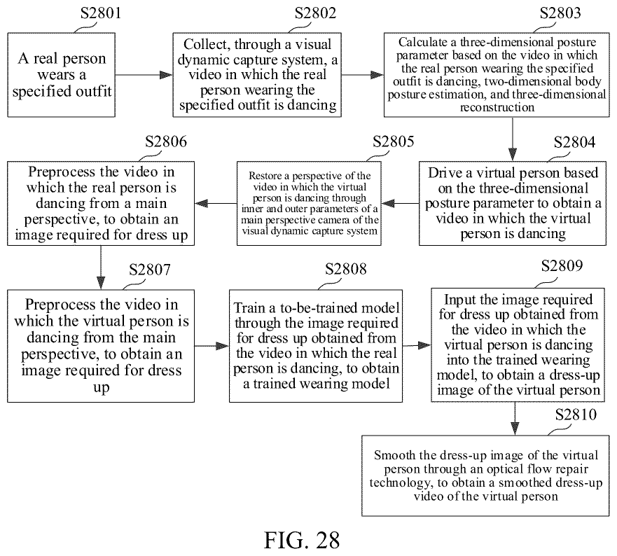

FIG. 28 is a flowchart of a data processing method for a virtual scene according to some embodiments of this application. As shown in FIG. 28, the data processing method for a virtual scene includes at least S2801 to S2810. Detailed descriptions are as follows.

S2801: A real person wears a specified outfit.

S2802: Collect, through a visual dynamic capture system, a video in which the real person wearing the specified outfit is dancing.

The video collected through the visual dynamic capture system herein in which the real person wearing the specified outfit is dancing is the second video in the foregoing embodiment.

S2803: Calculate a three-dimensional posture parameter based on the video in which the real person wearing the specified outfit is dancing, two-dimensional body posture estimation, and three-dimensional reconstruction.

S2804: Drive a virtual person based on the three-dimensional posture parameter, to obtain a video in which the virtual person is dancing.

S2805: Restore a perspective of the video in which the virtual person is dancing through inner and outer parameters of a main perspective camera of the visual dynamic capture system.

The video in which the virtual person is dancing restored herein is the first video in the foregoing embodiment.

Since the video in which the real person wearing the specific outfit is dancing is obtained through the visual dynamic capture system, two-dimensional body key points (referred to as a plurality of sets of two-dimensional body key points) of the real person obtained by cameras from a plurality of perspectives may be involved. Then three-dimensional reconstruction is performed on the plurality of sets of two-dimensional body key points based on the inner and outer parameters of the camera, and fusing is performed to obtain a three-dimensional body skeleton in main perspective camera space. Then, an EasyMocap algorithm is used to convert the three-dimensional body skeleton into a sita angle parameter that drives a joint of the virtual person, to obtain corresponding global coordinates and a corresponding movement trajectory of the virtual person. Then, a pre-modeled three-dimensional virtual person is driven in a virtual engine based on the corresponding global coordinates and the corresponding movement trajectory of the virtual person, to restore the main perspective.

S2806: Preprocess the video in which the real person is dancing from a main perspective, to obtain an image required for dress up.

S2807: Preprocess the video in which the virtual person is dancing from the main perspective, to obtain an image required for dress up.

S2808: Train a to-be-trained model through the image required for dress up obtained from the video in which the real person is dancing, to obtain a trained wearing model.

S2809: Input the image required for dress up obtained from the video in which the virtual person is dancing into the trained wearing model, to obtain a dress-up image of the virtual person.

The obtained dress-up image of the virtual person herein is the image for displaying the virtual scene in the foregoing embodiment.

S2810: Smooth the dress-up image of the virtual person through an optical flow repair technology, to obtain a smoothed dress-up video of the virtual person.

In some embodiments, the smoothing the dress-up image of the virtual person through an optical flow repair technology includes: performing frame supplementation on the dress-up image of the virtual person.

For detailed descriptions of S2801 to S2810 shown in FIG. 28, refer to the foregoing embodiment. Details are not described herein again.

Next, a detailed process in which the virtual person wears the outfit of the real person is introduced.

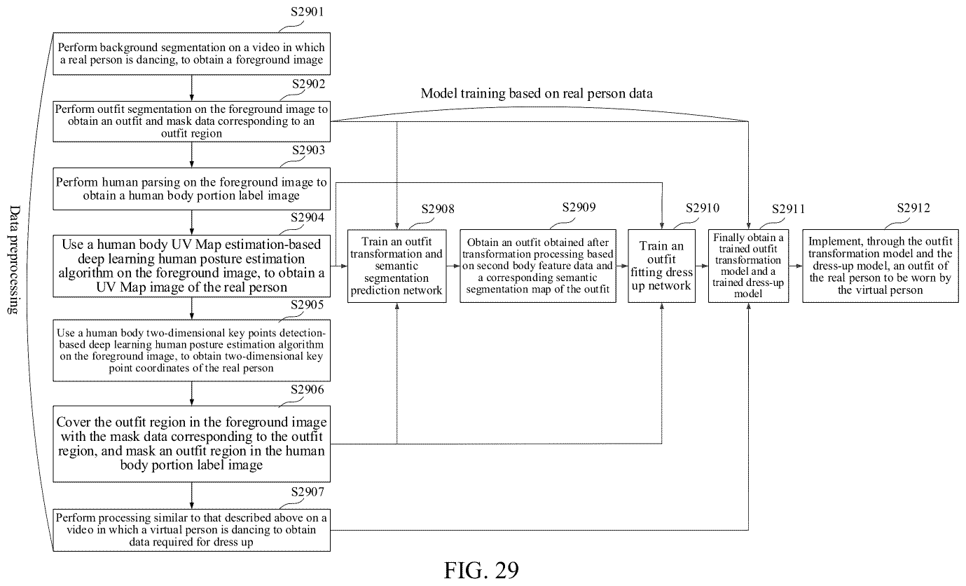

FIG. 29 is a flowchart of a data processing method for a virtual scene according to some embodiments of this application. As shown in FIG. 29, the data processing method includes at least S2901 to S2912. Detailed descriptions are as follows.

S2901: Perform background segmentation on a video in which a real person is dancing, to obtain a foreground image.

S2902: Perform outfit segmentation on the foreground image, to obtain an outfit and a mask image corresponding to an outfit region.

S2903: Perform human parsing on the foreground image to obtain a human body portion label image, a human body portion and clothing being segmented into a plurality of semantically consistent regions in the human body portion label image.

S2904: Use a human UV Map estimation-based deep learning human posture estimation algorithm (for example, dense pose estimation) on the foreground image to obtain a UV Map image of the real person, and map pixels describing a human body in a 2D image to a 3D human body surface model.

In some embodiments, the human UV Map estimation-based deep learning human posture estimation algorithm is a DensePose estimation algorithm.

S2905: Use a human body two-dimensional key points detection-based deep learning human posture estimation algorithm on the foreground image, to obtain two-dimensional key point coordinates of the real person.

In some embodiments, the human body two-dimensional key points detection-based deep learning human posture estimation algorithm is an OpenPose estimation algorithm.

The two-dimensional key point coordinates herein are the second body portion position information in the foregoing embodiment.

S2906: Cover the outfit region in the foreground image based on the mask image corresponding to the outfit region, and mask an outfit region in the human body portion label image.

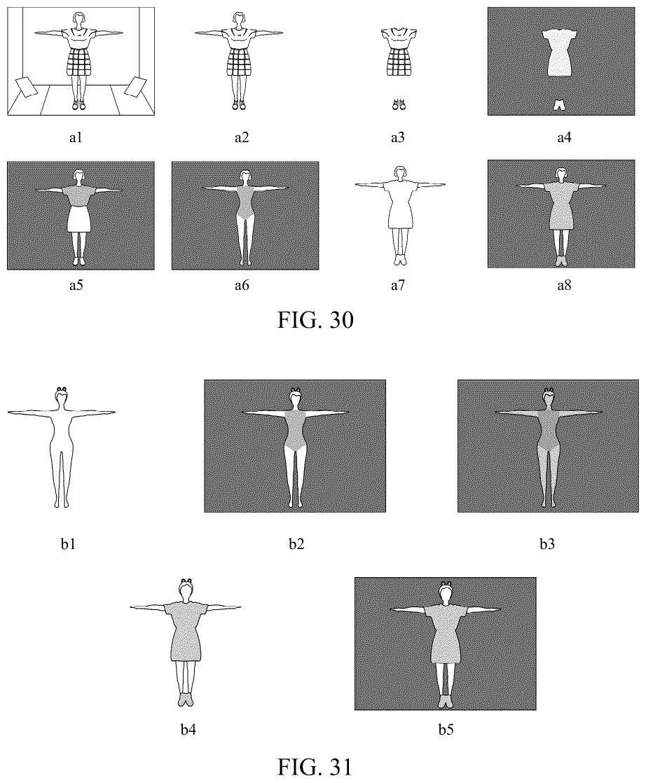

For ease of understanding, refer to FIG. 30.
a1 is an image corresponding to the video in which the real person is dancing.
a2 is the foreground image of the real person; and corresponds to the image of the real object wearing the target outfit in the foregoing embodiment.
a3 is the outfit image of the real person; and corresponds to the outfit image in the foregoing embodiment.
a4 is the mask image (that is, the mask image) corresponding to the outfit region of the real person; and corresponds to the outfit mask image in the foregoing embodiment.
a5 is the human body portion label image of the real person.
a6 is the UV Map image of the real person, and the image includes the two-dimensional key point coordinates of the real person, where the two-dimensional key point coordinates correspond to the second body portion position information in the foregoing embodiment.
a7 is an image obtained by covering the outfit region in the foreground image of the real person based on the mask image corresponding to the outfit region of the real person.
a8 is an image obtained after masking the outfit region in the human body portion label image of the real person.

In this way, preprocessing of the video in which the real person is dancing at the main perspective is completed, to obtain the image required for dress up.

S2907: Perform processing similar to that described above on a video in which the virtual person is dancing, to obtain an image required for dress up.

For detailed descriptions of preprocessing the video in which the virtual person is dancing at the main perspective to obtain the image required for dress up, refer to S2901 to S2906. Details are not described herein again.

Refer to FIG. 31.
b1 is a foreground image of the virtual person; and corresponds to the first image in the foregoing embodiment.
b2 is a human body portion label image of the virtual person.
b3 is a UV Map image of the virtual person, and the image includes two-dimensional key point coordinates of the virtual person, where the two-dimensional key point coordinates correspond to the first body portion position information in the foregoing embodiment.
b4 is an image obtained by covering an outfit region in the foreground image of the virtual person based on the mask image corresponding to the outfit region of the real person, and corresponds to the second image in the foregoing embodiment.
b5 is an image obtained after masking an outfit region in the human body portion label image of the virtual person.

In this way, preprocessing of the video in which the virtual person is dancing at the main perspective is completed, to obtain the image required for dress up.

S2908: Train an outfit transformation model and a semantic segmentation prediction network (the semantic segmentation prediction network may be used for segmenting a first image to obtain an outfit image).

S2909: Obtain an outfit obtained after transformation based on a posture of the real person and a semantic segmentation image (the outfit image) of a corresponding outfit.

S2910: Train an outfit fitting dress up network (a dress-up model).

S2911: Finally obtain a trained outfit transformation model and a trained dress-up model.

The outfit transformation model and the dress-up model are collectively referred to as a wearing model in the foregoing embodiments.

S2912: Implement, through the outfit transformation model and the dress-up model, wearing of the outfit of the real person on the virtual person.

For detailed descriptions of S2901 to S2912 shown in FIG. 29, refer to the foregoing embodiment. Details are not described herein again.

Next, a training process of the model is introduced.

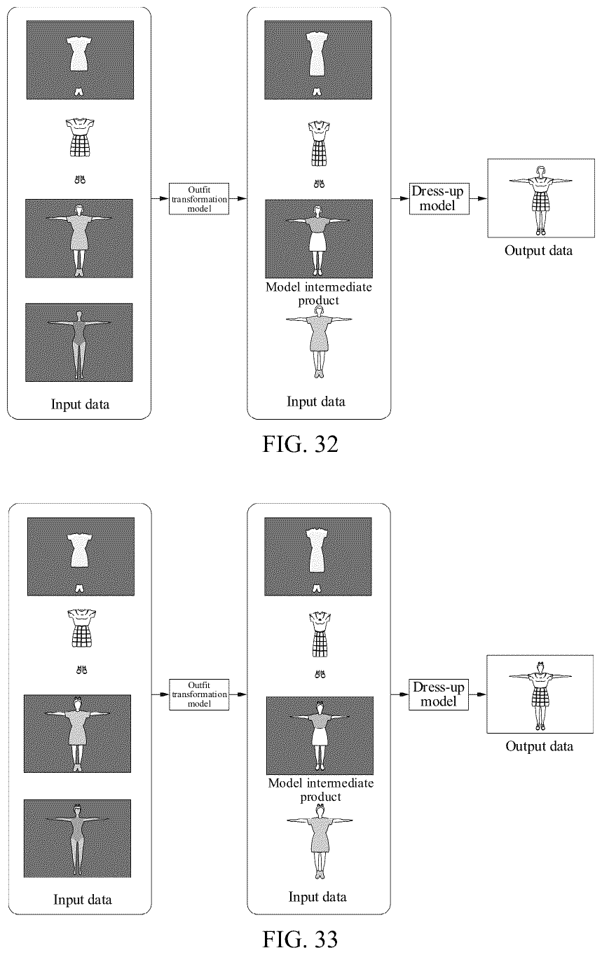

Based on the image shown in FIG. 30, FIG. 32 relates to training processes of an outfit transformation model and a dress-up model.

For the outfit transformation model:

Input data is: the mask image corresponding to the outfit region of the real person, the outfit image of the real person, the image obtained by performing mask processing on the outfit region in the human body portion label image of the real person, and the UV Map image of the real person. The inputted mask image corresponding to the outfit region of the real person and the inputted outfit image of the real person are subjected to data augmentation.

Output data is: the mask image corresponding to the outfit region obtained after transformation of the real person (compared with the inputted mask image corresponding to the outfit region of the real person (that is, before transformation), a position of the outfit in the entire image is more centered), the outfit image obtained after transformation of the real person (compared with the inputted outfit image of the real person (that is, before transformation), the position of the outfit in the entire image is more centered), and the image obtained after the outfit region in the human body portion label image of the real person (this image and the image obtained after mask processing is performed on the outfit region in the human body portion label image of the real person jointly form a model data pair, and the model data pair is constructed by the model) is filled. The output data herein is also referred to as a model intermediate product.

For the dress-up model:

Input data is: the mask image corresponding to the outfit region obtained after transformation of the real person, the outfit image obtained after transformation of the real person, the image obtained by filling the outfit region in the human body portion label image of the real person, and the image obtained by covering the outfit region in the foreground image of the real person (for a specific obtaining process, refer to the foregoing embodiment).

Output data is: the dress-up image of the real person.

Finally, an application process of the model is described.

Based on the data shown in FIG. 30 and FIG. 31, FIG. 33 relates to an application process of an outfit transformation model and a dress-up model.

For the outfit transformation model:

Input data is: the mask image corresponding to the outfit region of the real person, the outfit image of the real person, the image obtained by performing mask processing on the outfit region in the human body portion label image of the virtual person, and the UV Map image of the virtual person.

Output data is: the mask image corresponding to the outfit region obtained after transformation of the real person (compared with the inputted mask image corresponding to the outfit region of the real person (that is, before transformation), the outfit is more longer), the outfit image obtained after transformation of the real person (compared with the inputted outfit image of the real person (that is, before transformation), the outfit is more longer), and the image obtained after the outfit region in the human body portion label image of the virtual person (this image and the image obtained after mask processing is performed on the outfit region in the human body portion label image of the virtual person jointly form a model data pair) is filled.

For the dress-up model:

Input data is: the mask image corresponding to the outfit region obtained after transformation of the real person, the outfit image obtained after transformation of the real person, the image obtained by filling the outfit region in the human body portion label image of the virtual person, and the image obtained by covering the outfit region in the foreground image of the virtual person (for a specific obtaining process, refer to the foregoing embodiment).

Output data is: the dress-up image of the virtual person.

In this embodiment of this application, in a process of the virtual object wearing the outfit of the real object, there is no need to perform three-dimensional modeling on the outfit, thereby reducing tedious operations of three-dimensional modeling. In addition, since the actions of the virtual object and the real object are simultaneous, there is no need to solve the three-dimensional modeled outfit, thereby reducing tedious operations of outfit solving. In this way, wearing efficiency of the virtual object is greatly improved, processing resources such as three-dimensional modeling and solving are correspondingly saved, and corresponding costs are reduced.

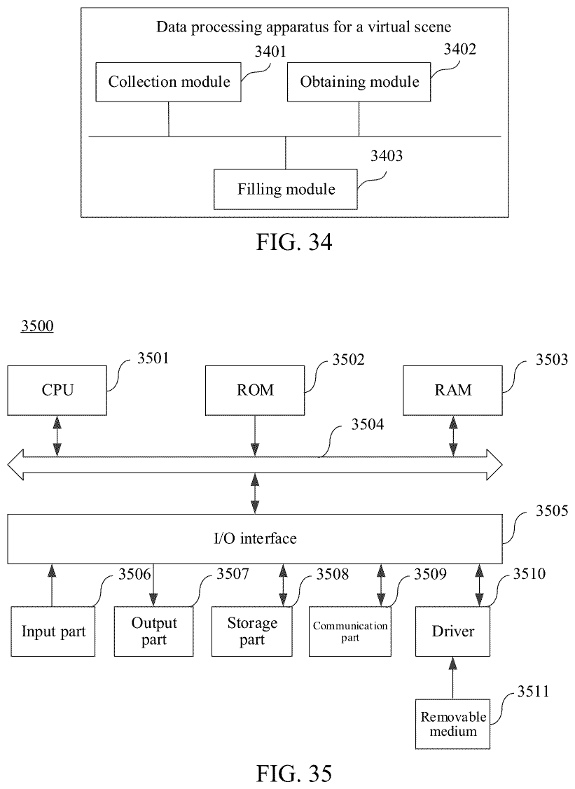

FIG. 34 is a block diagram of a data processing apparatus for a virtual scene according to some embodiments of this application. As shown in FIG. 34, the data processing apparatus for a virtual scene is used in a terminal device or a server. The apparatus includes:
a collection module 3401, configured to obtain an image of a real object wearing a target outfit, and segment an outfit image of the target outfit from the image;
an obtaining module 3402, configured to obtain a first image of the virtual object before dressing up from a first video of the virtual object; the virtual object in the first video being driven by a three-dimensional posture parameter of the real object; and
a filling module 3403, configured to fill a wearing region in the first image of the virtual object with the outfit image, to obtain an image for displaying the virtual scene, the virtual object wearing the target outfit in the virtual scene.

The apparatus provided in the foregoing embodiment and the method provided in the preceding embodiment are based on the same concept. The specific manners of performing operations by each module and unit of the apparatus have been described in detail in the method embodiment.

An embodiment of this application further provides an electronic device, including: one or more processors; and a memory, configured to store one or more programs, the one or more programs, when executed by the one or more processors, causing the electronic device to implement the foregoing data processing method for a virtual scene.

FIG. 35 is a schematic structural diagram of a computer system adapted to implement an electronic device according to an embodiment of this application.

A computer system 3500 of the electronic device shown in FIG. 35 is merely an example, and does not constitute any limitation on functions and use ranges of the embodiments of this application.

As shown in FIG. 35, the computer system 3500 includes a central processing unit (CPU) 3501, which may perform various suitable actions and processing based on a program stored in a read-only memory (ROM) 3502 or a program loaded from a storage part 3508 into a random access memory (RAM) 3503, for example, perform the method described in the foregoing embodiments. The RAM 3503 further has various programs and data required for operating the system stored therein. The CPU 3501, the ROM 3502, and the RAM 3503 are connected to each other through a bus 3504. An input/output (I/O) interface 3505 is also connected to the bus 3504.

The following components are connected to the I/O interface 3505: an input part 3506 including a keyboard, a mouse, and the like; an output part 3507 including a cathode ray tube (CRT), a liquid crystal display (LCD), a speaker, and the like; a storage part 3508 including hard disk, and the like; and a communication part 3509 including a network interface card such as a local area network (LAN) card, a modem, and the like. The communication part 3509 performs communication processing by using a network such as the Internet. A drive 3510 is also connected to the I/O interface 3505 as required. A removable medium 3511, such as a disk, an optical disc, a magneto-optical disc, or a semiconductor memory, is installed on the drive 3510 as required, so that a computer program read from the removable medium 3511 is installed in the storage part 3508 as required.

Particularly, according to an embodiment of the present application, the processes described above by referring to the flowcharts may be implemented as computer software programs. For example, an embodiment of this application includes a computer program product. The computer program product includes a computer program stored in a computer-readable medium. The computer program includes a computer program used for performing a method shown in the flowchart. In such an embodiment, the computer program may be downloaded and installed through the communication part 3509 from a network, and/or installed from the removable medium 3511. When the computer program is executed by the CPU 3501, the various functions defined in the system of this application are executed.

The computer-readable medium shown in the embodiments of this application may be a computer-readable signal medium or a computer-readable storage medium or any combination of two. The computer-readable medium may be, for example, an electrical, magnetic, optical, electromagnetic, infrared, or semiconductor system, apparatus, or device, or any combination thereof. More specific examples of the computer readable medium may include, but are not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this application, the computer-readable medium may be any tangible medium containing or storing a program, and the program may be used by or used in combination with an instruction execution system, an apparatus, or a device. In this application, a computer-readable signal medium may include a data signal in a baseband or propagated as a part of a carrier wave, the data signal carrying a computer-readable computer program. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, apparatus, or device. The computer program included in the computer-readable storage medium may be transmitted using any suitable medium, including but not limited to: a wireless medium, a wire medium, or the like, or any suitable combination thereof.

The flowcharts and block diagrams in the accompanying drawings illustrate possible system architectures, functions, and operations that may be implemented by a system, a method, and a computer program product according to various embodiments of this application. Each box in a flowchart or a block diagram may represent a module, a program segment, or a part of code. The module, the program segment, or the part of code includes one or more executable instructions used for implementing designated logic functions. In some implementations used as substitutes, functions marked in boxes may alternatively occur in a sequence different from that marked in an accompanying drawing. For example, actually two boxes shown in succession may be performed basically in parallel, and sometimes the two boxes may be performed in a reverse sequence. This is determined by a related function. Each box in the block diagram or the flowchart, and a combination of blocks in the block diagram or the flowchart may be implemented by using a dedicated hardware-based system that performs a specified function or operation, or may be implemented by using a combination of dedicated hardware and computer instructions.

Related units described in the embodiments of this application may be implemented in a software manner, or may be implemented in a hardware manner, and the unit described can also be set in a processor. Names of the units do not constitute a limitation on the units in a specific case.

Another aspect of this application further provides a non-transitory computer-readable medium, having a computer program stored therein. The computer program, when executed by a processor, implements the data processing method for a virtual scene as described above. The computer-readable medium may be included in the electronic device described in the foregoing embodiments, or may exist alone and is not disposed in the electronic device.

Another aspect of this application further provides a computer program product or a computer program, including computer instructions, the computer instructions being stored in a computer-readable medium. A processor of a computer device reads the computer instructions from the computer-readable medium, and the processor executes the computer instructions to cause the computer device to perform the data processing method for a virtual scene provided in the foregoing various embodiments.

The term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. What is described above is merely exemplary embodiments of this application, and is not intended to limit the embodiments of this application. A person of ordinary skill in the art can easily make equivalent changes or modifications according to the main concept and spirit of this application. Therefore, the protection scope of this application is subject to the protection scope specified in the claims.

What is claimed is:

1. A method for changing an outfit of a virtual object in a virtual scene performed by an electronic device, the method comprising:
segmenting an outfit image of a target outfit from an image of a real object wearing the target outfit;
obtaining a first image of the virtual object from a first video of the virtual object, the first video including an action of the virtual object driven by a three-dimensional posture parameter of the real object in a real world; and
filling a wearing region in the first image of the virtual object with the outfit image, to obtain an image of the virtual object wearing the target outfit in the virtual scene.

2. The method according to claim 1, wherein the filling a wearing region in the first image of the virtual object with the outfit image comprises:
transforming the target outfit in the outfit image based on the first image, to obtain a transformed outfit image, wherein a target outfit in the transformed outfit image matches a body feature of the virtual object; and
filling the wearing region in the first image of the virtual object with the transformed outfit image.

3. The method according to claim 1, wherein the filling a wearing region in the first image of the virtual object with the outfit image comprises:
performing body key point extraction on the first image, to obtain first body portion position information;
determining, based on the first body portion position information, the wearing region of the virtual object in the first image; and
filling the wearing region of the virtual object with the outfit image.

4. The method according to claim 1, wherein the filling a wearing region in the first image of the virtual object with the outfit image comprises:
obtaining an outfit mask image corresponding to the outfit image;
covering the wearing region in the first image based on the outfit mask image, to obtain a second image of the virtual object; and
filling a wearing region of the virtual object in the second image with the outfit image.

5. The method according to claim 1, wherein the filling a wearing region in the first image of the virtual object with the outfit image comprises:
transforming the first image of the virtual object based on the outfit image, to obtain a third image of a transformed virtual object, wherein the third image matches a body portion of the real object; and
filling a wearing region in the third image with the outfit image.

6. The method according to claim 1, wherein the image of the real object wearing the target outfit is obtained by:
collecting a second video in which the real object wearing the target outfit performs an action; and
obtaining, from the second video, an image of the real object wearing the target outfit.

7. The method according to claim 1, wherein the method further comprises:
collecting, through cameras arranged at a plurality of perspectives, videos in which the real object wearing the target outfit performs an action, to obtain third videos at the plurality of perspectives;
performing three-dimensional reconstruction processing based on two-dimensional body key points of the real object comprised in each third video, to obtain the three-dimensional posture parameter of the real object; and
driving the virtual object to perform an action matching the three-dimensional posture parameter, to obtain the first video.

8. The method according to claim 1, wherein the wearing region in the first image of the virtual object is filled with the outfit through a trained deep convolutional neural network model; and the method further comprises:
obtaining sample data, wherein the sample data comprises an outfit sample image, and a first sample image and a second sample image of a sample real object; and the second sample image is obtained by covering a wearing region in the first sample image; and
training, through the sample data, a to-be-trained deep convolutional neural network model, to obtain the trained deep convolutional neural network model.

9. An electronic device, comprising:
one or more processors; and
a memory, configured to store one or more programs, the one or more programs, when executed by the electronic device, causing the electronic device to implement a method for changing an outfit of a virtual object in a virtual scene including:
segmenting an outfit image of a target outfit from an image of a real object wearing the target outfit;
obtaining a first image of the virtual object from a first video of the virtual object, the first video including an action of the virtual object driven by a three-dimensional posture parameter of the real object in a real world; and
filling a wearing region in the first image of the virtual object with the outfit image, to obtain an image of the virtual object wearing the target outfit in the virtual scene.

10. The electronic device according to claim 9, wherein the filling a wearing region in the first image of the virtual object with the outfit image comprises:
transforming the target outfit in the outfit image based on the first image, to obtain a transformed outfit image, wherein a target outfit in the transformed outfit image matches a body feature of the virtual object; and
filling the wearing region in the first image of the virtual object with the transformed outfit image.

11. The electronic device according to claim 9, wherein the filling a wearing region in the first image of the virtual object with the outfit image comprises:
performing body key point extraction on the first image, to obtain first body portion position information;
determining, based on the first body portion position information, the wearing region of the virtual object in the first image; and
filling the wearing region of the virtual object with the outfit image.

12. The electronic device according to claim 9, wherein the filling a wearing region in the first image of the virtual object with the outfit image comprises:
obtaining an outfit mask image corresponding to the outfit image;
covering the wearing region in the first image based on the outfit mask image, to obtain a second image of the virtual object; and
filling a wearing region of the virtual object in the second image with the outfit image.

13. The electronic device according to claim 9, wherein the filling a wearing region in the first image of the virtual object with the outfit image comprises:
transforming the first image of the virtual object based on the outfit image, to obtain a third image of a transformed virtual object, wherein the third image matches a body portion of the real object; and
filling a wearing region in the third image with the outfit image.

14. The electronic device according to claim 9, wherein the image of the real object wearing the target outfit is obtained by:
collecting a second video in which the real object wearing the target outfit performs an action; and
obtaining, from the second video, an image of the real object wearing the target outfit.

15. The electronic device according to claim 9, wherein the method further comprises:
collecting, through cameras arranged at a plurality of perspectives, videos in which the real object wearing the target outfit performs an action, to obtain third videos at the plurality of perspectives;
performing three-dimensional reconstruction processing based on two-dimensional body key points of the real object comprised in each third video, to obtain the three-dimensional posture parameter of the real object; and
driving the virtual object to perform an action matching the three-dimensional posture parameter, to obtain the first video.

16. The electronic device according to claim 9, wherein the wearing region in the first image of the virtual object is filled with the outfit through a trained deep convolutional neural network model; and the method further comprises:
obtaining sample data, wherein the sample data comprises an outfit sample image, and a first sample image and a second sample image of a sample real object; and the second sample image is obtained by covering a wearing region in the first sample image; and
training, through the sample data, a to-be-trained deep convolutional neural network model, to obtain the trained deep convolutional neural network model.

17. A non-transitory computer-readable medium, having a computer program stored therein, the computer program, when executed by a processor of an electronic device, causing the electronic device to implement a method for changing an outfit of a virtual object in a virtual scene including:
segmenting an outfit image of a target outfit from an image of a real object wearing the target outfit;
obtaining a first image of the virtual object from a first video of the virtual object, the first video including an action of the virtual object driven by a three-dimensional posture parameter of the real object in a real world; and
filling a wearing region in the first image of the virtual object with the outfit image, to obtain an image of the virtual object wearing the target outfit in the virtual scene.

18. The non-transitory computer-readable medium according to claim 17, wherein the filling a wearing region in the first image of the virtual object with the outfit image comprises:
transforming the target outfit in the outfit image based on the first image, to obtain a transformed outfit image, wherein a target outfit in the transformed outfit image matches a body feature of the virtual object; and
filling the wearing region in the first image of the virtual object with the transformed outfit image.

19. The non-transitory computer-readable medium according to claim 17, wherein the image of the real object wearing the target outfit is obtained by:
collecting a second video in which the real object wearing the target outfit performs an action; and
obtaining, from the second video, an image of the real object wearing the target outfit.

20. The non-transitory computer-readable medium according to claim 17, wherein the method further comprises:
collecting, through cameras arranged at a plurality of perspectives, videos in which the real object wearing the target outfit performs an action, to obtain third videos at the plurality of perspectives;
performing three-dimensional reconstruction processing based on two-dimensional body key points of the real object comprised in each third video, to obtain the three-dimensional posture parameter of the real object; and
driving the virtual object to perform an action matching the three-dimensional posture parameter, to obtain the first video.
